(19) United States
(12) Patent Application Publication
(10) Pub. No.: US 2005/0189377 A1
(43) Pub. Date: Sep. 1, 2005

(54) Dispenser and cosmetic or dermatological preparation comprising an auxiliary for use with dispenser

(75) Inventors: Ghita Lanzendorfer, Hamburg (DE); Stephan Ruppert, Hamburg (DE); Claudia Mundt, Bremen (DE); Volker Kallmayer, Hamburg (DE); Lorenz Eckers, Tostedt (DE)

Correspondence Address: ALSTON & BIRD LLP;BANK OF AMERICA PLAZA, 101 SOUTH TRYON STREET, SUITE 4000, CHARLOTTE, NC, 28280-4000, US

(73) Assignee: Beiersdorf AG

(21) Appl. No.: 10/990,947

(22) Filed: Nov. 17, 2004

(30) Foreign Application Priority Data
Nov. 17, 2003 (DE) 103 54 051.2

(51) Int. Cl. B67B 7/00; G01F 11/00

(52) U.S. Cl. 222/1

(57) ABSTRACT

The present invention is a cosmetic or dermatological preparation for use with a dispenser that includes an auxiliary to keep the dispenser operating smoothly. The auxiliary is selected from the group consisting of (i) polyols having 2 to 6 carbon atoms and 2 to 6 hydroxyl or alkoxy groups and (ii) surfactants that reduce the surface tension of the preparation to less than 30 mN/m. The preparation is particularly suitable with a dispenser comprising a container and an inner container wall for housing a cosmetic or dermatological preparation; a follow-up plunger on a base side of the dispenser, which is capable of being slidably displaced on the inner container wall under the pressure of the ambient atmosphere; a head section on a top end of the dispenser that can be slidably displaced in relation to the container and that comprises a dispensing channel, the dispensing channel capable of being connected in a communicating manner to the container; a manually actuable delivery device comprising a variable-volume delivery chamber, a delivery element that can be displaced longitudinally in relation to the container and the head section, comprising a delivery plunger that can be slidably displaced within the delivery chamber and a delivery stem connected to the delivery plunger, and a delivery channel circumferentially enclosed by the delivery stem and comprising a delivery-channel inlet opening communicating with the delivery chamber and a delivery-channel outlet opening. The delivery channel outlet opening is capable of being moved into an open position relative to the dispensing channel by displacing the delivery element.

### FIELD OF THE INVENTION

The present invention relates to a cosmetic preparation and to a dispenser for cosmetic preparations having an essentially cylindrical container which contains the cosmetic preparation, has, on the base side, a follow-up plunger, which can be displaced for sliding action on an inner container wall under the pressure of the ambient atmosphere, and bears, at its top end, a head section which can be displaced for sliding action in relation to the container, has a dispensing channel for the product, it being possible for this dispensing channel to be connected in a communicating manner to the container, and acts on a manually actuable delivery device with a variable-volume delivery chamber for the product.

### BACKGROUND OF THE INVENTION

Dispensers with follow-up plungers which can be displaced for sliding action and manually actuable delivery devices with a variable-volume delivery chamber are known as portable supply containers in a large number of use examples, e.g. for body care, in medicine for the application of medicaments or also for the commercial supply of pasty foodstuffs. The configuration of the dispensers used for supplying the very different pasty substances is also correspondingly varied, in particular in respect of the actual delivery and handling mechanism of these dispensers.

Such a dispenser is known, for example, from EP-A-0 230 252. In the case of this known dispenser, the manually actuable delivery device has a delivery plunger which can vary the volume of the delivery chamber. The delivery plunger is latched to a tube section which is integrally formed on the head part. During use of the dispenser, the head section is displaced axially in the direction of the container, by manual actuation, from a starting position.

This displacement movement results directly in the delivery plunger sliding along the inner wall of the delivery chamber, with the volume of the latter being reduced. The internal pressure which is built up here in the delivery chamber results, in the first instance, in the opening action of a non-return valve which is formed in the delivery plunger, covers a through-passage opening of the delivery plunger in an elliptical manner and by way of which the pasty product, as the volume of the delivery chamber is further reduced, is then delivered in the direction of the dispensing channel for removal at a product-discharge opening formed on the head part.

In the case of the known dispenser, an internal pressure which overcomes the closure forces of the non-return valve has to be built up in the first instance in the delivery chamber.

It is also the case that delivering the pasty substance by way of the non-return valve results in a loss in pressure, which is disadvantageous in so far as, in order to compensate for this loss in pressure, increased compressive forces have to be applied in order to displace the head part axially in the direction of the container. There is also the problem of product which is delivered by way of the non-return valve being present in those delivery regions of the dispenser which are arranged downstream of the non-return valve, as seen in the conveying direction. These delivery regions, however, are in constant communication with the surroundings via the product-discharge opening, which may result in the pasty products being adversely affected. The quality of foodstuffs in respect of taste and colour is often influenced by oxidation. The effectiveness of drugs can be adversely affected under the influence of air.

WO 03/004374 discloses a dispenser of the type mentioned in the introduction which is improved to the extent where actuation with lower actuating forces is possible and, furthermore, the situation where the pasty product which is to be discharged is adversely affected by oxidation is reduced. The delivery device here comprises a delivery element which can be displaced longitudinally in relation to the container and the head section and has a delivery plunger which can be displaced for sliding action in the delivery chamber and is connected to a delivery stem which circumferentially encloses a delivery channel which has a delivery-channel inlet opening, communicating with the delivery chamber, and a delivery-channel outlet opening which, by virtue of a displacement movement of the delivery element relative to the head section, can be moved into a position in which the delivery-channel outlet opening opens in relation to the dispensing channel.

### SUMMARY OF THE INVENTION

In the case of the dispenser of the specification, the delivery chamber opens in relation to the dispensing channel via a delivery-channel outlet opening which is released via a longitudinal displacement of the delivery element relative to the head section. This relative movement is preferably achieved in that the head section is manually actuated, i.e. is axially displaced for sliding action in the direction of the container. The through-passage of the pasty product from the delivery chamber to the product-discharge opening at the end of the dispensing channel is thus already released by a translatory movement of the head section relative to the delivery element. There is no need for a prior build-up of pressure in the delivery chamber, as was necessary in the case of the generically determinative prior art for the purpose of releasing the through-passage. This results in a reduction in the actuating forces for discharging pasty products from the dispenser.

In the case of the dispenser of the specification, a delivery channel enclosed by a delivery stem is provided downstream of the delivery chamber. At the end of this delivery channel, the pasty product delivered out of the delivery chamber is discharged through the delivery-channel outlet opening into the dispensing channel. It is only once the product has been discharged from the delivery-channel outlet opening that it is present in the dispensing channel.

The remaining dispensing channel, in any case, is shorter than in the case of the dispensers which are usually used. Accordingly, a considerably lesser volume of pasty substance is adversely affected by any possible oxidation processes. The remaining length of the dispensing channel can be shortened, in particular in the case of those products which are highly susceptible to oxidation, by the dispensing channel being open in the outward direction in extension of the end side of the head section.

In the case of an advantageously configuration of the dispenser of the specification, the delivery-channel outlet opening is made on the circumferential surface of the delivery stem, and a bushing which covers the delivery-channel outlet opening in the starting position of the delivery device is provided on the head section, with the result that, in the case of a displacement movement of the head part in order for pasty substance to be delivered out, release of the delivery-channel outlet opening is usually achieved by the delivery stem being moved relative to the bushing. This preferred configuration is not just straightforward, but also allows the delivery-channel outlet opening to be arranged in the immediate vicinity of the inlet opening of the dispensing channel for the product which is to be delivered.

With regard to good axial guidance of the delivery device relative to the head section, the abovementioned bushing is preferably designed as a guide bushing for the delivery device and has at least one guide surface interacting with the circumferential surface of the delivery stem.

In respect of the delivery-channel outlet opening being forcibly closed when the head section is returned into the starting position, it is proposed, according to a preferred development of the present invention, that provided on the head part and on the delivery device are carry-along means by way of which the delivery device is carried along into the starting position, following manual actuation, when the head part is returned.

The above-mentioned carry-along means are easily formed preferably by a carry-along shoulder which is formed on the bushing and interacts with a carry-along ring integrally formed on the delivery stem. This carry-along ring is preferably integrally formed at the end of the delivery stem, with the result that the delivery-channel outlet opening made beneath the carry-along ring can be sealed in the starting position by abutment of the carry-along ring against walls of the head part.

In the case of the preferred configuration mentioned above, the volume present in the dispensing channel can be further reduced by the carry-along shoulder being formed at the end of the bushing, and that the transition to the dispensing channel, and the carry-along ring being formed in the end region of the delivery stem, which is closed at the end, as is proposed according to a preferred development of the present invention. In the case of this preferred configuration, the stem cup, which is arranged at the end of the delivery stem, covers the dispensing channel in an essentially flush manner in the starting position of the delivery device and preferably has the carry-along ring.

According to a preferred development of the present invention, the delivery piston is preferably actuated via the end surfaces of the guide bushing. In the case of this preferred development, the delivery piston projects radially beyond the delivery stem in order to form an annular abutment surface for a pressure-exerting surface which is formed on the end side of the guide bushing and which, in the starting position, is spaced apart axially from the abutment surface and, by virtue of the head section being displaced axially in the direction of the container, can be positioned on the abutment surface.

Likewise with regard to a simplification in design, it is proposed, according to a further preferred configuration of the present invention, to form the inner wall of the delivery chamber by an inner sleeve which is provided on the head-section end side of the container. In this case, the inner sleeve projects beyond the end side of the container on the side which is directed towards the head section. In order to reduce the number of components, the inner sleeve is preferably integrally formed on the container.

For straightforward centring of the head section during assembly of the dispenser and easy fastening of the head section on the container, a mating head section is proposed according to a preferred development of the present invention, this mating head section having a retaining cylinder, which is fitted in a cup-like manner onto the abovementioned inner sleeve, and a guide cylinder, which is arranged concentrically in relation to the retaining cylinder and guides the sliding displacement of the head section. The guide cylinder and/or the retaining cylinder allow/allows easy concentric alignment of the head part in relation to the cylinder. Furthermore, the guide cylinder improves the guidance of the displacement movement of the head section during actuation of the dispenser.

In the case of a further preferred configuration of the dispenser of the specification, in the case of which the delivery-chamber end of the guide cylinder forms a stop for the delivery plunger, the delivery plunger is guided in a relatively elongate manner on the one hand, and the displacement of the delivery plunger is easily limited, on the other hand. Such a displacement-limiting action secures, for example, the head part in the starting position on the container when the carry-along means are in operative connection.

The retaining cylinder preferably has a base-side annular shoulder which forms an abutment surface for a helical spring which retains the head section under prestressing in the starting position. This provides the advantage that the outer circumferential surface of the retaining cylinder encloses the helical spring on the inside and thus prevents the spring from buckling. In the case of this preferred configuration, the annular shoulder is positioned on the end side of the container and is thus suitable, in particular, for securing the mating head section in the axial direction in relation to the container.

According to a further, particularly preferred configuration, the mating head section and the head section are formed as a prefabricated dispenser component. In this case, the head section and the mating head section particularly preferably have their outer lateral surface pushed over one another in a cup-like manner in each case, the mating head section having at least one stop for limiting the axial displacement movement of the head section relative to the mating head section. In the case of such a configuration, a restoring element, for example the abovementioned helical spring which retains the head section and the mating head section under prestressing at an axial distance apart, is preferably located in the interior enclosed by the lateral surfaces. The abovementioned stop limits the axial displacement movement of the head section, i.e., following assembly of the head section and mating head section with the inclusion of the spring, ensures that the two components, which can be displaced in relation to one another, are held together. The resulting dispenser component can be positioned on containers of different configurations, which allows cost-effective production of the dispenser for very different applications and container volumes.

A particularly straightforward and durable connection between the prefabricated dispenser component and the container is formed by the dispenser component being latched to the container via latching means formed on the mating head section and the end side of the container.

In the case of the dispenser of the specification, the head section can preferably be displaced lengthwise such that it can be moved by means of manual actuation from the starting position, in the first instance by a first axial distance in order to butt against the delivery plunger, with simultaneous exposure of the delivery-channel outlet opening in the dispensing channel, into a central position, and it can then be moved, upon continued axial displacement, with the delivery plunger being carried along, from the central position into a final dispensing position, in which the delivery chamber, by virtue of displacement of the delivery plunger, has reached its smallest volume. In the case of this preferred configuration, the operations of exposing the delivery-channel outlet opening and compressing the substance in the delivery channel take place within the framework of the head section moving in the same direction towards the container. This dispenser of the specification allows a straightforward design solution for the preferred dispenser, in the case of which the head section acts directly on the delivery plunger and drives the latter, following exposure of the delivery-channel outlet opening, in order to delivery pasty substance. This movement of the head section usually takes place counter to the force of a prestressing element, for example of a spring, which ensures that, when the head section is relieved of loading, it pushes away from the container and the final dispensing position. During this movement, first of all the axial distance a is covered, i.e. the delivery-channel outlet opening is closed again. During this closure movement, the delivery stem and the dispensing channel move relative to one another, which results in an increase in the volume of the dispensing channel at its inlet. The pasty substance located in the dispensing channel is thus drawn back in the direction of the pumping chamber, that is to say is moved away from the product-discharge opening of the dispensing channel in the head part.

According to a preferred configuration of the invention, a closure part is located at this product-discharge opening. The closure part is preferably of such a nature that it opens in order to discharge the pasty product on account of a difference in pressure between the dispensing channel and the atmosphere. If—as mentioned above—the pasty substance in the dispensing channel is drawn back away from the product-discharge opening, then this results in a relative negative pressure in the dispensing channel, which ensures that the closure part seals the product-discharge opening in a particularly effective manner.

In respect of the best possible sealing, it is preferable to form the product-discharge opening around a closure pin arranged in the dispensing channel.

This closure pin is preferably integrally formed on the head part. The likewise annular closure part has a sealing lip which can be positioned for sealing action on the closure pin and, in the case of an active negative pressure, closes the dispensing channel in an effective manner but, for delivering out the pasty product, releases a comparatively large product-discharge opening through which the product can be delivered out with a relatively low loss in pressure.

A highly effective closure part can be formed in a particularly cost-effective manner on the head part by means of two-component injection moulding, as is proposed according to a preferred development of the present invention. In the case of this configuration, the closure part is fixed to the head part. The closure part is preferably formed from a soft/resilient plastic, particularly preferably from a thermoplastic elastomer. It has been found that effective sealing of the product-discharge opening can be achieved, in particular, by a thermoplastic elastomer.

It has been found that the material for the sealing part can be utilized in a particularly preferable manner for forming a functional surface on the end-side outer surface of the head part. Such a functional surface may be, for example, a pushing surface which improves the haptic properties and against which the user of the dispenser pushes when using the same. Such a functional surface is preferably formed by a coating at least on the end side of the exterior of the head part. The closure part and the coating are formed in one piece, preferably by means of two-component injection moulding following the injection moulding of the head part.

### BRIEF DESCRIPTION OF THE DRAWINGS

Further details, advantages and features of the present invention can be gathered from the following description of an exemplary embodiment in conjunction with the drawing, in which:

FIG. 1 shows a view, in longitudinal section, of a first exemplary embodiment of a dispenser of the specification; and

FIG. 2 shows a view, in longitudinal section, of a second exemplary embodiment of the dispenser of the specification.

### DETAILED DESCRIPTION OF THE PREFERRED EMBODIMENTS

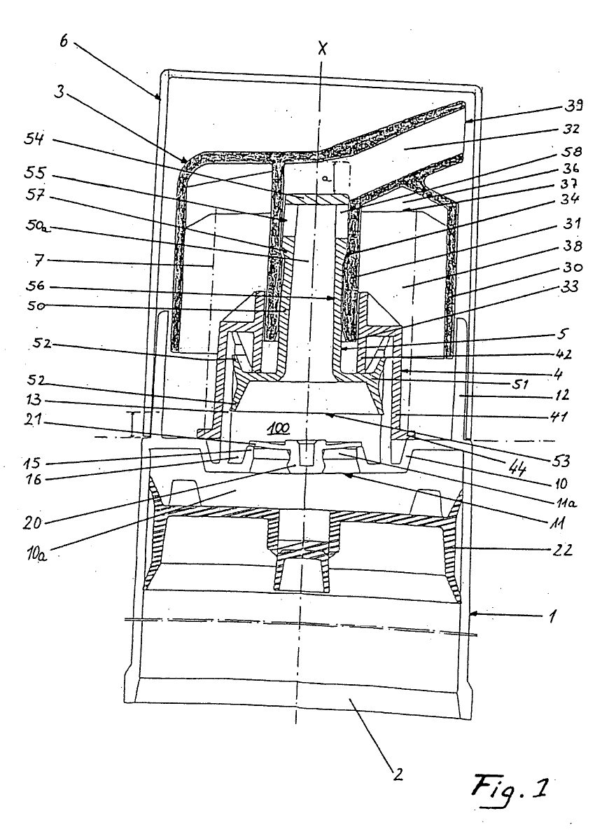

That exemplary embodiment of a dispenser of the specification which is shown in FIG. 1 has a container 1 which is of cup-like design and is connected, on its underside, to a base plate 2 which is latched to the container 1. On its other end side, the container 1 has a head-side covering 10, in which a container opening 11 is made. This covering 10, on the side which is directed away from the container 1, is formed for accommodating a dispenser head, comprising a head section 3, a mating head section 4 and a pressure-exerting plunger 5. The dispenser also has a closure cap 6 pushed onto an outer sleeve 12 of the container 1, the outer sleeve extending above the covering 10. The container 1, the base plate 2, the mating head section 4 and the pressure-exerting plunger 5 are designed as rotationally symmetrical components and are arranged concentrically in relation to a centre longitudinal axis X. Located between the head section 3 and the mating head section 4 is a schematically indicated helical spring 7 by means of which the head section 3 is retained in a prestressed state in relation to the mating head section 4 in the starting position shown in FIG. 1.

The head section 3 has a cylindrical outer shell 30, which is arranged radially within, and directly adjacent to, the outer sleeve 12 of the container 1 and concentrically in relation to the same. The outer sleeve 12 of the container 1 projects axially beyond the container end of the outer shell 30. Accordingly, that exemplary embodiment of the dispenser which is shown in FIG. 1, even with the closure cap removed, appears as a closed unit comprising the container 1 and the head section 3. As is explained in more detail hereinbelow, the head section 3 and the pressure-exerting plunger 5 are retained in a longitudinally displacement manner in relation to the container 1, the pressure-exerting plunger 5, furthermore, being longitudinally displaceable in relation to the head section 3.

The cylindrical wall of the container 1 encloses an interior 10a for accommodating the cosmetic or dermatological preparation. Retaining crosspieces 11a which are oriented in the form of a star extend in the container opening 11. On that side of the covering 10 which is directed away from the interior 10a, a cylindrical inner sleeve 13 is arranged concentrically in relation to the container opening 11, has the outer sleeve 12 projecting axially beyond it and encloses a delivery chamber 100. The inner wall of the inner sleeve 13 is smooth. The base of the delivery chamber 100 is formed by the covering 10 of the container 1. The covering 10 has an annular ring 15 which projects into the delivery chamber 100, encloses the container opening 11 and forms an annular gap 16 between itself and the inner sleeve 13.

The pressure-exerting plunger 5 has an essentially cylindrical, internally hollow delivery stem 50 with a delivery plunger 51 integrally formed at one end. The delivery plunger 51 projects radially beyond the delivery stem 50 and has, on its outer circumferential surface, respective top and bottom sealing lips 52 which project axially beyond the essentially annular delivery piston 51. On an end side which is directed towards the delivery stem 50, the delivery plunger 51 forms an annular abutment surface.

The delivery stem 50 has, at one end, a delivery-channel inlet opening 53 which is made in the centre of the annular delivery plunger 51. At its other end, the delivery stem 50 is closed on the end side by a stem cup 54. The stem cup 54 covers a cylinder portion 55 of the delivery stem 50, this portion having a larger diameter than the rest of the stem region 56. An obliquely outwardly inclined carry-along ring 57 is located between this stem region 56 and the cylinder portion 55. Between the carry-along ring 57 and the stem cup 54, a plurality of delivery-channel outlet openings 58 are distributed over the outer circumferential surface of the cylinder portion 55. Retaining crosspieces, which bear the stem cup 54, extend in the circumferential direction between the delivery-channel outlet openings 58. The delivery-channel inlet opening 54 communicates with the delivery-channel outlet openings 58 via a delivery channel 50a enclosed by the delivery stem 50, and forms a delivery passage for the pasty substance which is free of non-return valves.

The head section 3 has a cylindrical outer shell 30 with an internally hollow guide bushing 31 arranged concentrically in relation to it, this guide bushing communicating with a dispensing channel 32. The end of the guide bushing 32 forms an end-side pressure-exerting surface 33, which has the outer shell 30 projecting axially beyond it. The guide bushing 31 has, adjacent to the end-side pressure-exerting surface 33, a first bushing portion, which has a smaller internal diameter than the second bushing portion, which is located behind the first as seen in the delivery direction of the pasty substance. Formed between the first and the second bushing portions is a carry-along shoulder 34, which connects the two different-diameter portions to one another via a slope. The second bushing portion opens out into a dispensing channel 32, which projects laterally from the centre longitudinal axis X.

Approximately at right angles to the centre longitudinal axis X, the head section 3 has spring-abutment surfaces 37 formed on ribs 36. The ribs 36 extend approximately in the form of a star from the bushing 31 to the inner surface of the outer shell 30. Accordingly, an annular space 38 which is open towards the underside of the head section 3 is formed between the inner surface of the outer shell 30, the outer surface of the guide bushing 31 and the spring-abutment surfaces 37.

The head part 3 is opened towards the container side of the outer shell 30 and, above this end side, is formed essentially in the manner of a cap. A product-discharge opening 39 of the dispensing channel 32 is located on the top side of the head part 3, the top side being directed away from the end side of the outer shell 30.

The mating head section 4 has essentially two concentric cylinder portions, namely an outer retaining cylinder 41 and a smaller-diameter guide cylinder 42. The retaining cylinder 41 projects beyond the guide cylinder 42 on the side which is directed towards the container 1, whereas the guide cylinder 42 projects beyond the retaining cylinder 41 on the other side. Provided on that end side of the retaining cylinder 41 which is directed away from the container 1 is an annular crosspiece which extends radially inwards from there and butts approximately centrally against the outer surface of the guide cylinder 42.

The retaining cylinder 41 has an outwardly projecting encircling annular shoulder on its container end side. The container end side of the guide cylinder 42 forms a delivery-plunger stop.

In the assembled state, the delivery plunger 51 of the pressure-exerting plunger 5 is located for sliding displacement in the inner sleeve 13 of the container 1 and thus covers the delivery chamber 100 on the end side. The mating head section 4 is arranged concentrically in relation to the inner sleeve 13 and has its retaining cylinder 41 pushed in a cup-like manner over the inner sleeve 13. The annular shoulder of the mating head section 4 butts against that end side of the covering 10 which is directed away from the container 1.

The annular shoulder of the mating head section 4 is located approximately in the region of the end of the inner sleeve 13. The radially inwardly adjoining guide cylinder 42 encloses the end of the guide bushing 31 of the head part 3. Located radially within this guide bushing 31 is the delivery stem 50 with its smaller-diameter stem region 56. The delivery plunger 51 of the pressure-exerting plunger 5 is arranged for sliding displacement on the inner wall of the inner sleeve 13. The annular abutment surface of the delivery plunger 51 butts against the end side of the delivery-plunger stop of the guide cylinder 42. This retains the prestressing force to which the head section 3 is subjected by the spring 7 and which, via the abutment of the carry-along shoulder 34 and carry-along ring 57, prestresses the pressure-exerting plunger 5 in a direction away from the container 1.

Located between the delivery chamber 100 and the interior 10a of the container 1 is a container valve 20 which is designed in a manner known per se, butts, by way of its sealing washer 21, against the annular ring 15 of the covering 10 and seals the interior 10a in relation to the delivery chamber 100.

When not in use, the dispenser is located in the starting position (0). During use of the dispenser, a user pushes the head section 3 in the direction of the container 1. On account of the incompressibility of the substance contained in the delivery chamber 100 and the delivery channel 50a, the pressure-exerting plunger 5 remains in position. The head section 3 moves relative to the pressure-exerting plunger 5 in the direction of the container 1. The form-fitting abutment between the carry-along ring 57 and the carry-along shoulder 34 is released until the stem cup 54 strikes against the inner surface of the bushing head 35 or—depending on the configuration—the end-side pressure-exerting surface 33 at the end of the guide bushing 31 ends up in abutment against the annular abutment surface 51a of the delivery plunger 51 (central position M). Following this axial displacement by the displacement distance a, the delivery-channel outlet openings 58 are exposed in the dispensing channel 32.

In the case of this as with any other axial relative movement between the head section 3 and the mating head section 4 and/or between the head section 3 and the container 1, the head section 3 is guided for sliding action by the abutment of the outer circumferential surface of the guide bushing 31 against the inner circumferential surface of the guide cylinder 42. The relative movement between the head section 3 and the pressure-exerting plunger 5 is guided via the abutment of the circumferential surface of the second stem portion against the stem region 56.

As the movement of pushing the head section 3 in the direction of the container 1 continues, the pressure-exerting plunger 5 is carried along. The volume of the delivery chamber 100 decreases here, with the result that the pasty product located downstream of the container valve 30, as seen in the conveying direction, is discharged via the delivery-channel outlet opening 58 in the dispensing channel 32. The pasty product leaves the dispensing channel via the product-discharge opening 39 of the same.

At the end of this relative movement of the head section 3 in the direction of the container 1, the container-side sealing lips 52 of the pressure-exerting plunger 5 strike against the end side of the annular gap 16. In this final dispensing position V, the delivery chamber 100 has reached its smallest volume.

If the head section 3 is then released by the user, the helical spring 7 pushes the head section 3 back in the opposite direction. In the first instance here, the pressure-exerting plunger 5 remains in its final dispensing position V. It is merely the head section 3 which moves away from the container 1, to be precise until the carry-along shoulder 34 ends up in abutment against the carry-along ring 57.

During this axial displacement by the distance a, the pasty product located in the dispensing channel 32 is drawn back into the space formed between the stem cap 54 and the inside of the bushing head 35. Thereafter, at the end of this displacement movement, the pasty product no longer butts directly against the product-dispensing opening 39 of the dispensing channel 32, this preventing the situation where pasty product drips out of the dispensing channel 32 at the end of the delivery operation or is adversely affected by soiling in the region of the product-dispensing opening 39.

Following the displacement by the distance a and the abutment of the carry-along ring 57 and carry-along shoulder 34, the pressure-exerting plunger 5 is also moved back, as movement of the head section 3 continues, in the direction of the starting position, which is reached when the delivery-plunger stop butts against the annular abutment surface of the delivery plunger 51. In the case of the relative movement of the pressure-exerting plunger 5 away from the container 1, pasty product is delivered out of the interior 10a of the container 1, through the container opening 11, into the delivery chamber 100. The relative negative pressure produced in the interior 10a here results, in a manner known per se, in a follow-up movement of the follow-up plunger 22 located in the interior 10a.

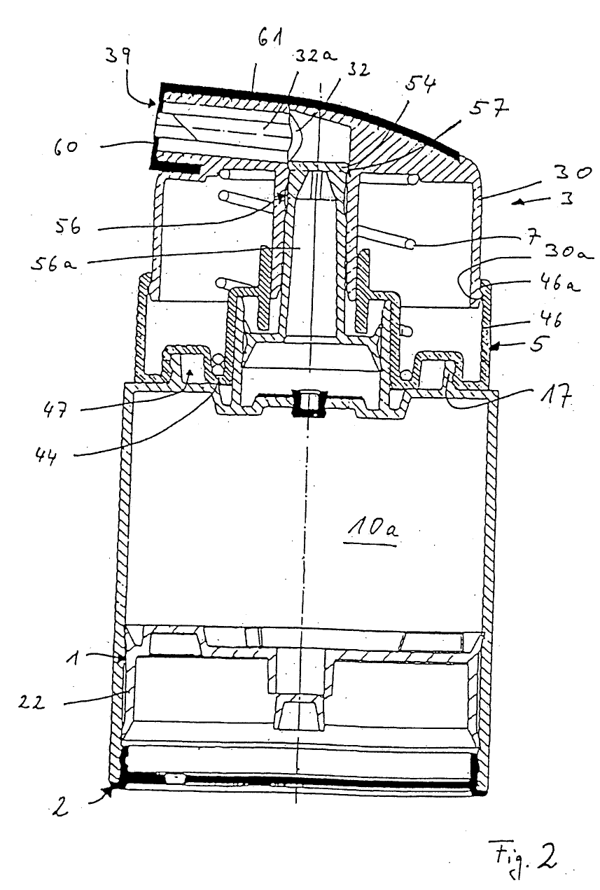

FIG. 2 shows a second exemplary embodiment of the dispenser of the specification.

Parts for this exemplary embodiment which are the same as those for the previously discussed exemplary embodiment are provided with the same designations. The container 1 of the exemplary embodiment which is shown in FIG. 2 is designed essentially identically to the abovedescribed container, with an outer container wall which encloses an interior 10a in which a follow-up plunger 22 is arranged in a longitudinally displaceable manner and which is closed by a base plate 2. In contrast to the abovedescribed exemplary embodiment, the container 1 has an encircling latching ring 17 on its end-side covering. The mating head section 4 is extended radially outwards beyond the annular shoulder 44 and has a cylindrical outer wall 46 which extends essentially parallel to the retaining cylinder 51 and of which the diameter is larger than the diameter of the outer shell 30 of the head section 3. A latching recess 47 is formed between the outer wall 46 and the retaining cylinder 41, on the underside of the mating head section 4, the underside being directed towards the container, and interacts with the latching ring 17 in order to form a latching connection between the mating head section 4 and the container 1.

In the case of the exemplary embodiment which is shown in FIG. 2, the mating head section 4, together with the head section 3, is formed as a prefabricated dispenser component. The free end of the outer wall 46 of the mating head section 4, this free end being directed away from the container 1, is angled radially inwards in order to form a latching nose 46a and projects axially beyond an annular bead 30a which is provided on the outside of the outer shell 30 of the head section 3. This results in the formation of a stop by means of which the mating head section 4 is connected in captive fashion to the head section 3. This stop retains the spring forces applied by the spring 7. The dispenser component comprising the head section 3 and the mating head section 4 can thus be pre-assembled prior to being fitted onto the container 1. For this purpose, the spring 7 is inserted into the cavity between the head section 3 and the mating head section 4. The two components 3, 4 are pushed axially one inside the other until the annular bead 30a has slid past the inwardly bent-over end of the outer wall 46.

In the case of the exemplary embodiment which is shown in FIG. 2, the pressure-exerting plunger 5 has a carry-along ring 57 which is integrally formed on the stem cap 54. Accordingly, in the case of the starting position which is shown in FIG. 2, the carry-along ring 57 seals the dispensing channel 32. The delivery stem 50 has a stem region 56 of reduced diameter, the longitudinal extent of this stem region corresponding to the axial distance a. Accordingly, the axial displaceability of the pressure-exerting plunger 5 in relation to the head part 3 is defined by the stem cap 54, on the one hand, and the longitudinal extent of the stem region 56 of reduced diameter, on the other hand.

The exemplary embodiment which is shown in FIG. 2 has the further difference, in relation to the first exemplary embodiment mentioned above, that the dispensing channel 32 contains a closure pin 32a which is integrally formed on the head section 3. The product-discharge opening 39 encloses the closure pin 32a in an annular manner. In the case of the exemplary embodiment shown, the product-discharge opening 39 is covered by an annular closure part 60 which is connected to the head section 3 as a separate component made of a thermoplastic elastomer. In the starting position in FIG. 2, the closure part 60 butts against the outer circumferential surface and against parts of the end side, but in particular the circumferential surface, of the closure pin 32a and thus seals the dispensing channel 32. A coating 61 is formed integrally with the closure part 60, this coating being made of the same material as the closure part 60 and extending over a large part of the end-side covering of the head section 3. This coating 61 forms a non-slip functional surface on the head section 3.

When the dispenser which is shown in FIG. 2 is actuated, the operations explained above, in particular with reference to FIG. 1, take place. The difference here from the abovementioned exemplary embodiment, however, is that, when the pressure-exerting plunger 5 and head section 3 are returned, the dispensing channel is sealed in relation to the surroundings. In the case of the pressure-exerting plunger 5 moving relative to the head section 3 in the direction of the container 1, the product located in the dispensing channel 32—as has already been mentioned above—is drawn back into the interior of the head section 3 counter to the delivery direction. In the case of the exemplary embodiment which is illustrated in FIG. 2, the pressure gradient which is produced here between the atmosphere and the dispensing channel 32 results in the closure part 60 butting with full sealing action against the surfaces of the closure pin 32a. Accordingly, pasty product present in the dispensing channel 32 remains virtually unaffected by any possible oxidation processes. In addition, the stem cap 54 seals the delivery channel 50a in relation to the dispensing channel 32, with the result that, in particular, the situation where pasty product located in the delivery channel 50a is adversely affected by air possibly penetrating into the dispensing channel 32 is always avoided.

The two exemplary embodiments described above both have the advantage that the delivery-channel openings 58 are only exposed in the dispensing channel 32 following a relative movement between the head part 3 and the pressure-exerting plunger 5. It is not necessary, in order to deliver the pasty product out of this delivery chamber in the direction of the product-discharge opening 32a, for the initially built-up internal pressure in the delivery chamber 100 to be utilized for opening a downstream non-return valve, as seen in the conveying direction. Accordingly, the pasty product can be delivered out with a lower level of force being applied. The two exemplary embodiments mentioned above also have the advantage that the pasty product is drawn back in the dispensing channel 32 counter to the conveying direction following the actuation of the head section, the exemplary embodiment which is shown in FIG. 2 having the admissible advantage that, by virtue of the closure part 60 butting with sealing action against the closure pin 32a, the pasty product contained in the dispenser is reliably protected against being adversely affected, for example, by oxygen in the air.

List of Designations:

1 Container; 2 Base plate; 3 Head section; 4 Mating head section; 5 Pressure-exerting plunger; 6 Closure cap; 7 Helical spring; 10 Covering; 10a Interior; 11 Container opening; 11a Retaining crosspiece; 12 Outer sleeve; 13 Inner sleeve; 15 Annular ring; 16 Annular gap; 17 Latching ring; 20 Container valve; 21 Valve washer; 22 Follow-up plunger; 30 Outer shell; 30a Annular bead; 31 Guide bushing; 32 Dispensing channel; 32a Closure pin; 33 Pressure-exerting surface; 34 Carry-along shoulder; 36 Rib; 37 Spring-abutment surface; 38 Annular space; 39 Product-discharge opening; 41 Retaining cylinder; 42 Guide cylinder; 44 Annular shoulder; 46 Outer wall; 46a Latching nose; 47 Latching recess; 50 Delivery stem; 50a Delivery channel; 51 Delivery plunger; 52 Sealing lips; 53 Delivery-channel inlet opening; 54 Stem cap; 55 Cylinder portion; 56 Stem region; 57 Carry-along ring; 58 Delivery-channel outlet opening; 60 Closure part; 61 Coating; and 100 Delivery chamber

It is not in any way the case, however, that such dispensers are always suitable for cosmetic and/or dermatological products: it is indeed the case that this type of dispenser has the advantage that product residues do not run out of the dispenser opening. Unattractive soiling of the dispenser by product residues running out is thus avoided. A significant feature of the dispenser for the purpose of achieving this effect is a self-closing opening which is opened when the pump is actuated and is closed in the rest state. This specific construction, however, also gives rise to significant problems which vastly restrict the usability for cosmetic products.

Many products tend to clog in the opening of dispensers or, to form a hard plug, as a result of drying out, since they generally contain water which evaporates over time. In the case of the dispenser described, this gives rise to particularly severe problems, in particular if the contents are removed on an irregular basis, since the exit opening is virtually sealed tight in the rest position, which leads to the functional capability no longer being ensured if the dispenser is left unused over a relatively long period of time. When an attempt is made to apply the product, the closure only opens to some extent, if at all. This situation arises, in particular, if products are used in wet environments, because they are exposed to the risk of germs forming as a result of splash water. A bed of microbes perliberating on the closure does not just give rise to feelings of revolution in the user, but also obstructs the closure from moving because the gaps are no longer free. If the dispenser contains formulations containing film-forming polymers, for example hair-shaping preparations, the effect is similar: the closure mechanism clogs and the gaps are filled with polymer deposits. This results in malfunctioning. The specification mentioned above, however, does not indicate any solution to this problem.

Unforeseeable for the person skilled in the art, it has been found that the shortcomings of the prior art are remedied by a cosmetic product comprising a dispenser for pasty products having an essentially cylindrical container (1) which contains the pasty product, has, on the base side, a follow-up plunger (22), which can be displaced for sliding action on an inner container wall under the pressure of the ambient atmosphere, and bears, at its top end, a head section (3) which can be displaced for sliding action in relation to the container (1), has a dispensing channel (32) for the product, it being possible for this dispensing channel to be connected in a communicating manner to the container (1), and acts on a manually actuable delivery device with a variable-volume delivery chamber (100) for the product, characterized in that the delivery device comprises a delivery element (5) which can be displaced longitudinally in relation to the container (1) and the head section (3) and has a delivery plunger (51) which can be displaced for sliding action in the delivery chamber (100) and is connected to a delivery stem (50) which circumferentially encloses a delivery channel (50a) which has a delivery-channel inlet opening (53), communicating with a delivery chamber (100), and a delivery-channel outlet opening (58) which, by virtue of a displacement movement of the delivery element (5) relative to the head section (3), can be moved into a position in which the delivery-channel outlet opening (58) opens in relation to the dispensing channel (32), and also comprising a water-containing cosmetic and/or dermatological preparation with an auxiliary for keeping the dispenser operating smoothly and selected from the group of polyols having 2 to 6 carbon atoms and 2 to 6 hydroxyl or alkoxy groups and/or of surfactants which reduce the surface tension of the product to <30 mN/m.

Both solutions—addition of surfactants or polyols—result in the product not clogging, even when the dispenser opening is not in use over a relatively long period of time, in such a manner as to limit the functional capability of the dispenser. Polyols give rise to the products maintaining their flexibility, even in the case of some of the product water evaporating, and/or to some other product water being bound in the product, which effectively prevents the product from drying out completely. The addition of surfactants results in the product residues sticking less readily to the surface of the packaging since, as a result of a lower level of surface tension, the product can spread out better over the surface.

It has also been found that it is preferred if the delivery-channel outlet opening (58) is made on the circumferential surface of the delivery stem (50), and if the head section (3) has a bushing which covers the delivery-channel outlet opening (58) in the starting position (0) of the delivery device. It is also preferred if the bushing is designed as a guide bushing (31) which guides the delivery device in a longitudinally displaceably manner and has at least one guide surface interacting with the circumferential surface of the delivery stem (50).

It is also preferred if provided on the head section (3) and the delivery device are carry-along means (34, 57) by way of which the delivery device is carried along into the starting position (0), following manual actuation, when the head section (3) is returned. It is also preferred if a carry-along shoulder (34) is formed on the bushing (31) and interacts with a carry-along ring (57) integrally formed on the delivery stem (50). It is particularly preferred if the carry-along shoulder (34) is provided at the end of the bushing (31), at the transition to the dispensing channel (32), and the carry-along ring (57) is provided in the end region of the delivery stem (50). It is also preferred if the delivery plunger (51) projects radially beyond the delivery stem (50) in order to form an annular abutment surface, and if the guide bushing (31) has an end-side pressure-exerting surface (33) which, in the starting position (0), is spaced apart axially from the abutment surface and, by virtue of the head section (3) being displaced axially in the direction of the container (1), can be positioned on the abutment surface. It is also preferred if the inner wall of the delivery chamber (100) is formed by an inner sleeve (13) which is provided on the head-section end side of the container (1). It is also preferred if the dispenser has a mating head section (4) which has a retaining cylinder (41), which is fitted in a cup-like manner onto the inner sleeve (13), and a guide cylinder (42), which is arranged concentrically in relation to the retaining cylinder (41) and guides the sliding displacement of the head section (3). It is particularly preferred if the delivery-chamber end of the guide cylinder (42) has a stop for the delivery plunger (51). It is quite particularly preferred if the retaining cylinder (41) is provided with a base-side annular shoulder (44) which forms an abutment surface for a helical spring, retaining the head section under prestressing in the starting position (0), and is positioned on the end side of the container (1). It is also preferred if the mating head section (4) has at least one stop (46a) for limiting the axial displacement movement of the head section (3) and is formed, together with the head section (3), as a prefabricated dispenser component and is fastened on the end side of the container (1). It is preferred here if the dispenser component is latched to the container (1) via latching means (47; 17) formed on the mating head section (4) and the end side of the container (1). It is also preferred if the head section (3) can be dispensed longitudinally such that it can be moved by means of manual actuation from the starting position (0), in the first instance by a first axial distance (a) in order to butt against the delivery plunger, into a central position (M), with simultaneous exposure of the delivery-channel outlet opening (8) in the dispensing channel (32), and it can then be moved, upon continued axial displacement, with the delivery plunger (51) being carried along, from the central position (M) into a final dispensing position (V), in which the delivery chamber (100), by virtue of displacement of the delivery plunger (51), has reached its smallest volume. It is also preferred if the dispenser has a closure part (60) which is fastened on the head part and by means of which a product-discharge opening (39) of the dispensing channel (32) can be closed. It is preferred here if the product-discharge opening (39) is formed annularly around a closure pin (32a) arranged in the dispensing channel, and if the closure part (60) has an annular sealing lip which can be positioned for sealing action on the closure pin. It is particularly preferred here if the closure part (60) is formed from a soft/resilient plastic material, preferably from a thermoplastic elastomer. It is quite particularly preferred here if the closure part (60) is integral with a coating (61) formed at least on the end side of the exterior of the head part (3). The invention also covers described polyols or surfactants being used in an abovedescribed dispenser, containing water-containing cosmetic and/or dermatological preparations, as auxiliaries in order to keep the dispenser operating smoothly. With all that, it is particularly preferred if the polyol is glycerol or propylene glycol. These polyols are particularly well suited to keeping the dispenser operating smoothly because with them molar water-binding capacity is particularly favourable. The content of polyol is particularly preferably at least 0.1% by weight, very particularly preferably 0.5-20% by weight, very extraordinarily preferably 1-10% by weight, based on the weight of the preparation. It is further preferred if a surfactant with an HLB value of at least 10 is used. It is also particularly preferred if the surfactant chosen is an alkyl ether sulphate. This has the advantage that, due to the sulphate group, the ionization and thus the surface-active character is not dependent on the pH and thus a pH shift, for example as a result of drying out, does not impair the effect of the auxiliary for keeping the dispenser operating smoothly. It is also preferred if both polyol and surfactant are present. It is also preferred if the ratio of polyol to water is 1:3 to 1:25.

The omission of one of the individual constituents adversely affects the unique properties of the overall composition. Thus, all of the stated constituents of the preparations according to the invention are absolutely necessary in order to carry out the invention.

It may be advantageous if the preparations comprise further ingredients, such as emulsifiers, lipids, dyes, pigments, gel formers, polymers, powder raw materials, antioxidants, complexing agents, self-tanning agents, photoprotective agents, hair conditioning agents, cosmetic active ingredients, preservatives and/or skin moisturizers.

It is particularly advantageous if further polyols and/or surfactants are present. Such surfactants are amphiphilic substances which can dissolve organic, non-polar substances in water. As a result of their specific molecular structure having at least one hydrophilic molecular moiety and one hydrophobic molecular moiety, they are able to reduce the surface tension of the water, wet the skin, facilitate the removal and dissolution of soiling, facilitate rinsing and, if desired, control foaming.

The hydrophilic moieties of a surfactant molecule are mostly polar functional groups, for example —COO⁻, —OSO₃²⁻, —SO₃⁻, while the hydrophobic moieties are usually non-polar hydrocarbon radicals. Surfactants are generally classified according to the type and charge of the hydrophilic molecular moiety. In this connection, it is possible to differentiate between four groups:
anionic surfactants,
cationic surfactants,
amphoteric surfactants and
nonionic surfactants.

Anionic surfactants usually have, as functional groups, carboxylate, sulphate or sulphonate groups. In aqueous solution, they form negatively charged organic ions in an acidic or neutral medium. Cationic surfactants are characterized almost exclusively by the presence of a quaternary ammonium group. In aqueous solution, they form positively charged organic ions in an acidic or neutral medium. Amphoteric surfactants contain both anionic and cationic groups and accordingly in aqueous solution exhibit the behaviour of anionic or cationic surfactants depending on the pH. In a strongly acidic medium, they have a positive charge, and in an alkaline medium a negative charge. By contrast, in the neutral pH range, they are zwitterionic, as the example below aims to illustrate:
RNH₂⁺CH₂CH₂COOH X⁻ (at pH=2) X⁻=any anion, e.g. Cl⁻
RNH₂⁺CH₂CH₂COO⁻ (at pH=7)
RNHCH₂CH₂COO⁻B⁺ (at pH=12) B⁺=any cation, e.g. Na⁺
Polyether chains are typical of nonionic surfactants. Nonionic surfactants do not form ions in an aqueous medium.
A. Anionic Surfactants

Anionic surfactants which can be used advantageously are
acylamino acids (and salts thereof), such as
1. acyl glutamates, for example sodium acyl glutamate, di-TEA-palmitoyl aspartate and sodium caprylic/capric glutamate,
2. acylpeptides, for example palmitoyl-hydrolysed milk protein, sodium cocoyl-hydrolysed soya protein and sodium/potassium cocoyl-hydrolysed collagen,
3. sarcosinates, for example myristoyl sarcosinate, TEA-lauroyl sarcosinate, sodium lauroyl sarcosinate and sodium cocoyl sarcosinate,
4. taurates, for example sodium lauroyl taurate and sodium methylcocoyl taurate,
5. acyl lactylates, lauroyl lactylate, caproyl lactylate
6. alaninates
carboxylic acids and derivatives, such as
1. carboxylic acids, for example lauric acid, aluminium stearate, magnesium alkanolate and zinc undecylenate,
2. ester carboxylic acids, for example calcium stearoyl lactylate, laureth-6 citrate and sodium PEG-4 lauramide carboxylate,
3. ether carboxylic acids, for example sodium laureth-13 carboxylate and sodium PEG-6 cocamide carboxylate,
phosphoric esters and salts, such as, for example DEA oleth-10 phosphate and dilaureth-4 phosphate,
   sulphonic acids and salts, such as
1. acyl isethionates, e.g. sodium/ammonium cocoyl isethionate,
2. alkylarylsulphonates,
3. alkylsulphonates, for example sodium cocomonoglyceride sulphate, sodium C₁₂₋₁₄-olefinsulphonate, sodium lauryl sulphoacetate and magnesium PEG-3 cocamide sulphate,
4. sulphosuccinates, for example dioctyl sodium sulphosuccinate, disodium laureth sulphosuccinate, disodium lauryl sulphosuccinate, disodium undecylenamido-MEA sulphosuccinate and PEG-5 lauryl citrate sulphosuccinate.
   and
sulphuric esters, such as
1. alkyl ether sulphates, for example sodium, ammonium, magnesium, MIPA, TIPA laureth sulphate, sodium myreth sulphate and sodium C₁₂₋₁₃ pareth sulphate,
2. alkyl sulphates, for example sodium, ammonium and TEA lauryl sulphate.
   B. Cationic Surfactants

Cationic surfactants which can be used advantageously are
1. alkylamines,
2. alkylimidazoles,
3. ethoxylated amines and
4. quaternary surfactants,
5. ester quats

Quaternary surfactants contain at least one N atom which is covalently bonded to 4 alkyl and/or aryl groups. Irrespective of the pH, this leads to a positive charge. Alkylbetaine, alkylamidopropylbetaine and alkylamidopropylhydroxysultaine are advantageous quaternary surfactants. For the purposes of the present invention, cationic surfactants may also preferably be chosen from the group of quaternary ammonium compounds, in particular benzyltrialkylammonium chlorides or bromides, such as, for example, benzyldimethylstearylammonium chloride, and also alkyltrialkylammonium salts, for example cetyltrimethylammonium chloride or bromide, alkyldimethylhydroxyethylammonium chlorides or bromides, dialkyldimethylammonium chlorides or bromides, alkylamidoethyltrimethylammonium ether sulphates, alkylpyridinium salts, for example lauryl- or cetylpyridinium chloride, imidazoline derivatives and compounds with cationic character, such as amine oxides, for example alkyldimethylamine oxides or alkylaminoethyldimethylamine oxides. In particular, the use of cetyltrimethylammonium salts is advantageous.

C. Amphoteric Surfactants

Amphoteric surfactants which can be used advantageously are
1. acyl/dialkylethylenediamine, for example sodium acyl amphoacetate, disodium acyl amphodipropionate, disodium alkyl amphodiacetate, sodium acyl amphohydroxypropylsulphonate, disodium acyl amphodiacetate and sodium acyl amphopropionate,
2. N-alkylamino acids, for example aminopropylalkylglutamide, alkylaminopropionic acid, sodium alkylimidodipropionate and lauroamphocarboxyglycinate.
   D. Nonionic Surfactants

Nonionic surfactants which can be used advantageously are
1. alcohols,
2. alkanolamides, such as cocamides MEA/DEA/MIPA,
3. amine oxides, such as cocoamidopropylamine oxide,
4. esters which are formed by esterification of carboxylic acids with ethylene oxide, glycerol, sorbitan or other alcohols,
5. ethers, for example ethoxylated/propoxylated alcohols, ethoxylated/propoxylated esters, ethoxylated/propoxylated glycerol esters, ethoxylated/propoxylated cholesterols, ethoxylated/propoxylated triglyceride esters, ethoxylated/propoxylated lanolin, ethoxylated/propoxylated polysiloxanes, propoxylated POE ethers and alkyl polyglycosides, such as lauryl glucoside, decyl glycoside and cocoglycoside.
6. sucrose esters, sucrose ethers
7. polyglycerol esters, diglycerol esters, monoglycerol esters
8. methylglucose esters, esters of hydroxy acids

It is also advantageous to use a combination of anionic and/or amphoteric surfactants with one or more nonionic surfactants.

According to the invention, polyols advantageous according to the invention which may be used are all organic-chemical compounds with two or more alcohol functions. Preference according to the invention is given to the use of sorbitol, propylene glycol, dipropylene glycol, and butylene glycol, panthenol, carbohydrates (e.g. mono-, di-, oligo- and polysaccharides, such as hyaluronic acid, chitosan and/or a fucose-rich polysaccharide, which is filed in the Chemical Abstracts under the registry number 178463-23-5 and is available, for example, under the name Fucogel® 1000 from SOLABIA S. A.), hydroxy acids, in particular α-hydroxy acids, such as lactic acid and/or lactates, in particular sodium lactate and/or citric acid, ethylhexyloxyglycerol. The polyol particularly preferred according to the invention is glycerol.

With all that, it is possible in individual cases that the abovementioned concentration data are slightly exceeded or not reached and nevertheless preparations according to the invention are obtained. In view of the widely scattered diversity of suitable components of such preparations, this comes as no surprise to the person skilled in the art, so that he knows that such excesses or shortfalls do not depart from the essence of the present invention.

The examples below aim to illustrate the present invention without limiting it. The numerical values in the examples are percentages by weight, based on the total weight of the particular preparations.

### EXAMPLES

1) Showers and baths

| | 1 | 2 | 3 | 4 | 5 |
|---|---|---|---|---|---|
| Sodium laureth sulphate | 11.0% | 9.0% | 9.5% | 9.5% | 9.5% |
| Sodium myreth sulphate | | | | 3.0% | |
| Cocoamidopropylbetaine | 3.5% | 4.5% | 4.5% | 3.0% | 3.5% |
| Sodium cocoylglutamate | 1.5% | 2.0% | 2.5% | 1.5% | 2.5% |
| PEG-40 hydrogenated castor oil | 0.5% | 0.5% | 0.5% | 0.5% | 0.5% |
| PEG-7 glyceryl cocoate | | 2.3% | | | 1.5% |
| Glycerol | | | | 0.5% | |
| PEG-200 hydrogenated glyceryl palmitate | 0.5% | 0.3% | | 0.5% | 0.1% |
| PEG-90 glyceryl isostearate | | 0.3% | 0.8% | | 0.5% |
| Laureth-2 | | 0.1% | 0.1% | | 0.1% |
| Hydroxypropyl guar hydroxypropyl- | | | 0.2% | | |
| trimonium chloride | | | | | |
| Sodium chloride | 1.0% | 1.0% | | 2.0% | 1.0% |
| Trisodium EDTA | 0.2% | | | 0.2% | |
| Tetrasodium iminodisuccinate | | 0.8% | | | |
| Polyquaternium-10 | 0.2% | | | | 0.2% |
| Benzophenone-4 | | | | 0.1% | |
| Glycol distearate | | 0.6% | | | |
| Glycerol | | 0.3% | | | |
| Laureth-4 | | 0.3% | | | |
| Styrene/acrylate copolymer | 1.0% | | 1.0% | | 1.0% |
| Alcohol denat. | | 1.0% | | | |
| Plant extracts | | | 0.2% | | 0.2% |
| Natural oils | 0.2% | | | | |
| Preservative | q.s. | q.s. | q.s. | q.s. | q.s. |
| Dyes | q.s. | q.s. | q.s. | q.s. | q.s. |
| Citric acid | q.s. | q.s. | q.s. | q.s. | q.s. |
| Perfume | q.s. | q.s. | q.s. | q.s. | q.s. |
| Water | ad 100 | ad 100 | ad 100 | ad 100 | ad 100 |

| | 6 | 7 | 8 | 9 | 10 | 11 |
|---|---|---|---|---|---|---|
| Sodium laureth sulphate | 8.5% | 9.0% | 12.0% | 6.5% | 8.0% | 6% |
| Cocoamidopropylbetaine | 4.0% | 3.0% | 4.0% | 3.25% | 3.5% | 3.5% |
| Sodium cocoylglutamate | 2.5% | 2.0% | 0.5% | 0.2% | 0.5% | 0.5% |
| Decyl glucoside | 1.5% | | 0.5% | 2.0% | 4.0% | 3% |
| Disodium PEG-5 lauryl citrate | | 2.5% | | | | |
| sulphosuccinate | | | | | | |
| PEG-40 hydrogenated castor oil | 0.5% | 0.5% | 0.5% | 0.5% | 0.5% | 0.5% |
| PEG-7 glyceryl cocoate | | | 0.3% | 0.2% | 0.2% | 0.2% |
| Glycerol | 1.0% | | | | | |
| Glyceryl laurate | | | 0.2% | | | |
| PEG-200 hydrogenated glyceryl | 0.3% | 0.2% | 0.3% | 0.5% | | 2.5% |
| palmitate | | | | | | |
| PEG-90 glyceryl isostearate | | 0.2% | | | 0.3% | 0.2% |
| Laureth-2 | | 0.1% | | | 0.1% | 0.1% |
| PEG-120 methyl glucose dioleate | | | | 0.5% | | |
| Hydroxypropyl guar hydroxy- | | | | | 0.8% | |
| propyltrimonium chloride | | | | | | |
| Sodium chloride | 1.0% | 1.0% | 1.1% | 1.0% | | 0.5% |
| Trisodium EDTA | 0.2% | | | | | 1.0% |
| Tetrasodium iminodisuccinate | | 1.0% | | | | |
| Polyquaternium-10 | | | | | | |
| Benzophenone-4 | 0.1% | 0.1% | | | | |
| Glycol distearate | | | 0.8% | 0.6% | | 0.6% |
| Glycerol | | | 0.4% | 0.3% | | 0.3% |
| Laureth-4 | | | 0.4% | 0.3% | | 0.3% |
| Styrene/acrylate copolymer | | | | | 1.0% | |
| Plant extracts | | | | 0.05% | | |
| Natural oils | | | | | | 0.2% |
| Preservatives | q.s. | q.s. | q.s. | q.s. | q.s. | q.s. |
| Dyes | q.s. | q.s. | q.s. | q.s. | q.s. | q.s. |
| Citric acid | q.s. | q.s. | q.s. | q.s. | q.s. | q.s. |
| Perfume | q.s. | q.s. | q.s. | q.s. | q.s. | q.s. |
| Water | ad | ad | ad | ad | ad | ad |
| | 100 | 100 | 100 | 100 | 100 | 100 |

| | 12 | 13 | 14 | 15 | 16 | 17 | 18 | 19 |
|---|---|---|---|---|---|---|---|---|
| Sodium laureth | 13.2% | 11% | 9.5% | 5% | 9.5% | 10% | 9.5% | 7% |
| sulphate | | | | | | | | |
| Cocoamidopropyl- | 1.65% | 3.3% | 3.8% | 2% | 3.8% | 3.8% | 3.8% | 3.8% |
| betaine | | | | | | | | |
| Sodium | 1.25% | 0.75% | 2.5% | 1.5% | 2.5% | 1% | 2.5% | 2.5% |
| cocoylglutamate | | | | | | | | |
| Eumulgin HSP | 0.30% | 0.50% | 1% | 1.2% | 1% | 2% | 2% | 3% |
| PEG-7 glyceryl | — | 0.3% | — | — | 1% | — | — | — |
| cocoate | | | | | | | | |
| PEG-90 glyceryl | — | — | — | — | 0.5% | 0.5% | — | — |
| isostearate | | | | | | | | |
| Laureth-2 | — | — | — | — | 0.05% | 0.05% | — | — |
| PEG-200 | 0.50% | 0.50% | 0.5% | 0.7% | — | 0.1% | 0.5% | 0.5% |
| hydrogenated | | | | | | | | |
| glyceryl palmitate | | | | | | | | |
| Polyquaternium-10 | 0.2% | — | 0.2% | 0.1% | 0.2% | 0.2% | 0.2% | 0.2% |
| Sodium benzoate | 0.45% | 0.45% | 0.45% | 0.45% | 0.45% | 0.45% | 0.45% | 0.45% |
| Styrene acrylates | — | — | 0.3% | 0.2% | 0.3% | 0.3% | 0.3% | — |
| copolymer | | | | | | | | |
| Sodium salicylate | 0.20% | 0.20% | 0.2% | 0.2% | 0.2% | 0.2% | 0.2% | 0.2% |
| Citric acid | 0.50% | 0.50% | 0.5% | 0.5% | 0.5% | 0.5% | 0.5% | 0.5% |
| Tocopherol acetate | 0.2% | — | — | — | — | — | — | — |
| Ricinus communis | — | — | — | — | 0.3% | — | 0.5% | — |
| Cyclomethicone | — | — | 0.2% | — | — | 0.2% | 0.2% | 0.2% |
| Sodium chloride | — | — | — | 0.3% | 0.25% | — | 0.3% | — |
| Perfume | 0.5% | 0.5% | 0.5% | 0.5% | 0.5% | 3% | 1.5% | 4% |
| Water | ad | ad | ad | ad | ad | ad | ad | ad |
| | 100 | 100 | 100 | 100 | 100 | 100 | 100 | 100 |

| | 20 | 21 | 22 | 23 | 24 |
|---|---|---|---|---|---|
| Sodium myreth sulphate | 5% | 4% | 6% | 12% | 2.5% |
| Lauryl glucoside | 2.5% | — | — | 1% | 2.5% |
| Decyl glucoside | — | 3% | — | — | — |
| Sodium cocoamphoacetate | 6.5% | 7% | 8% | 3% | 4.5% |
| PEG-200 hydrogenated | 0.4% | 0.4% | 0.4% | 0.6% | 0.4% |
| glyceryl palmitate | | | | | |
| Eumulgin HSP | 1% | 1% | 1% | 0.5% | 0.8% |
| Diammonium citrate | 0.12% | 0.12% | 0.12% | 0.12% | 0.12% |
| Polyquaternium-10 | 0.2% | — | — | 0.15% | 0.2% |
| Sodium benzoate | 0.3% | 0.3% | 0.3% | 0.45% | 0.3% |
| Sodium salicylate | 0.2% | 0.2% | 0.2% | 0.45% | 0.2% |
| Citric acid | 1.2% | 1.2% | 1.2% | 1% | 1.2% |
| Persea gratissima | 0.3% | — | — | — | — |
| Paraffinum liquidum | — | 0.2% | — | — | — |
| Squalane | — | — | — | 0.1% | — |
| Perfume | 0.4% | 0.4% | 0.4% | 0.4% | 0.6% |
| Water | ad 100 | ad 100 | ad 100 | ad 100 | ad 100 |

| | 14 | 15 | 16 | 17 | 18 |
|---|---|---|---|---|---|
| Sodium laureth sulphate | 13.2% | 11% | 9.5% | 5% | — |
| Cocoamidopropylbetaine | 1.65% | 3.3% | 3.8% | — | — |
| Sodium cocoyl glutamate | 1.25% | 0.75% | 2.5% | 2% | 7% |
| Hydroxypropyl starch | 2% | 8% | 4% | 3% | 2% |
| phosphate ester | | | | | |
| (Structure XL) | | | | | |
| PEG-40 hydrogenated | 0.50% | 0.50% | 0.50% | 0.1% | 0.50% |
| castor oil | | | | | |
| PEG-100 hydrogenated | 0.50% | 0.50% | 0.50% | — | 0.50% |
| glyceryl palmitate | | | | | |
| Polyquaternium-10 | 0.2% | — | 0.2% | — | 0.2% |
| Sodium benzoate | 0.45% | 0.45% | 0.45% | 0.45% | 0.45% |
| Sodium salicylate | 0.20% | 0.20% | 0.2% | 0.20% | 0.2% |
| Citric acid | 0.50% | 0.50% | 0.5% | 0.50% | 0.5% |
| Perfume | q.s. | q.s. | q.s. | q.s. | q.s. |
| Water | ad 100 | ad 100 | ad 100 | ad 100 | ad 100 |

| | 19 | 20 | 21 | 22 | 23 |
|---|---|---|---|---|---|
| Sodium myreth sulphate | 5% | 4% | 6% | — | — |
| Sodium cocoyl glutamate | 2.5% | 1% | 5% | 3% | 1.8% |
| Decyl glucoside | — | 3% | — | 3% | 2% |
| Sodium cocoamphoacetate | 6.5% | 7% | 8% | — | — |
| Hydroxypropyl starch | 2% | 0.8% | 5% | 2% | 0.3% |
| phosphate ester | | | | | |
| (Structure XL) | | | | | |
| PEG-200 hydrogenated | 0.4% | 0.4% | 0.4% | — | — |
| glyceryl palmitate | | | | | |
| PEG-40 hydrogenated | 1% | 1% | 1% | 0.5% | 0.5% |
| castor oil | | | | | |
| Diammonium citrate | 0.12% | 0.12% | 0.12% | 0.12% | 0.12% |
| Polyquaternium-10 | 0.2% | — | — | — | 0.2% |
| Sodium benzoate | 0.3% | 0.3% | 0.3% | 0.3% | 0.3% |
| Sodium salicylate | 0.2% | 0.2% | 0.2% | 0.2% | 0.2% |
| Citric acid | 1.2% | 1.2% | 1.2% | 0.8% | 1% |
| Perfume | q.s. | q.s. | q.s. | q.s. | q.s. |
| Water | ad 100 | ad 100 | ad 100 | ad 100 | ad 100 |

2) Particle- or solids-containing cleansing products

| | 1 | 2 | 3 | 4 | 5 | 6 | 7 |
|---|---|---|---|---|---|---|---|
| Sodium laureth sulphate | 11.0% | 9.5% | 12.0% | | 9.0% | 12% | |
| Sodium myreth sulphate | | | | | | | 3.0% |
| Cocoamidopropylbetaine | 4.0% | 4.5% | | | | | 4.0% |
| Sodium cocoamphoacetate | | | | | 4.5% | 3.5% | |
| Decyl glucoside | | | 1.1% | 10.0% | | | |
| Lauryl glucoside | | | | | | | 1.0% |
| Sodium cocoyl glutamate | 1.5% | 2.5% | 0.8% | | 0.5% | 1.0% | |
| Acrylates copolymer | 3.0% | 2.5% | 2.2% | | | | 1.7% |
| Acrylates/C10-30 alkyl | | | | 1.0% | | | |
| acrylate crosspolymer | | | | | | | |
| Magnesium aluminium | | | | | 3.0% | 2.3% | |
| silicate | | | | | | | |
| Hydroxypropyl guar | | | | | 0.1% | 0.1% | |
| hydroxypropyltrimonium | | | | | | | |
| chloride | | | | | | | |
| Polyquaternium-10 | | | | | | | 0.1% |
| PEG-6 caprylic/capric | | | 1.0% | | | | |
| glycerides | | | | | | | |
| PEG-40 hydrogenated | 0.5% | 0.5% | 0.5% | 0.5% | 0.5% | 0.5% | 0.5% |
| castor oil | | | | | | | |
| Glycol distearate | 0.3% | | | | | | |
| Glycerol | 0.2% | | | | | | |
| Laureth-4 | 0.2% | | | | | | |
| PEG-7 glyceryl cocoate | | 1.5% | | | | | |
| Styrene/acrylate | | | 1.0% | | | | |
| copolymer | | | | | | | |
| PEG-3 distearate | | | | | 2.0% | 2.0% | |
| Butylene glycol | | | | 10.0% | | | |
| Propylene glycol | | | | 15.0% | | | |
| Trisodium EDTA | | 0.2% | | | | 0.2% | 0.2% |
| Benzophenone-4 | | 0.1% | | | | 0.1% | 0.1% |
| Polyethylene | 1.5% | | | | 5% | 2% | |
| Pigments | q.s. | q.s. | q.s. | q.s. | q.s. | q.s. | q.s. |
| Preservatives | q.s. | q.s. | q.s. | q.s. | q.s. | q.s. | q.s. |
| Dye | q.s. | q.s. | q.s. | q.s. | q.s. | q.s. | q.s. |
| Citric acid | q.s. | q.s. | q.s. | q.s. | q.s. | q.s. | q.s. |
| NaOH | q.s. | q.s. | q.s. | q.s. | q.s. | q.s. | q.s. |
| Perfume | q.s. | q.s. | q.s. | q.s. | q.s. | q.s. | q.s. |
| Water | ad | ad | ad | ad | ad | ad | ad |
| | 100 | 100 | 100 | 100 | 100 | 100 | 100 |

| | 7 | 8 | 9 | 10 | 11 |
|---|---|---|---|---|---|
| Sodium laureth sulphate | 2% | 1.2% | 2% | 5% | — |
| Methyl cocoyl taurate | 0.6% | 0.6% | 0.6% | — | 0.6% |
| Acyl glutamate | — | — | — | — | 1.5% |
| Decyl glucoside | — | 0.5% | — | 1% | 1.5% |
| Carbomer | 1.2% | 1.2% | 1.2% | 1.2% | 1.2% |
| PEG-40 hydrogenated castor oil | 1% | 1% | 1% | 0.5% | 0.8% |
| Sodium hydroxide | 0.5% | 0.5% | 0.5% | 0.5% | 0.5% |
| PEG-7 glyceryl cocoate | — | — | — | 0.7% | 0.3% |
| Glycerol | 2.0% | 2.0% | 2.0% | 2.0% | 2.0% |
| Xanthan gum | 0.25% | 0.25% | 0.25% | 0.25% | 0.25% |
| Polyethylene | — | — | 0.3% | — | — |
| Squalane | — | 0.2% | — | — | — |
| Prunus dulcis | 0.3% | — | 0.2% | 0.3% | — |
| Phenoxyethanol | 0.5% | 0.5% | 0.5% | 0.5% | 0.5% |
| Sodium chloride | — | — | 0.2% | 0.3% | — |
| Parabens | 0.2% | 0.2% | 0.2% | 0.2% | 0.2% |
| Perfume | 0.4% | 0.4% | 0.4% | 0.4% | 0.6% |
| Water | ad 100 | ad 100 | ad 100 | ad 100 | ad 100 |

3) Liquid soaps

| | 1 | 2 | 3 | 4 | 5 |
|---|---|---|---|---|---|
| Sodium laureth sulphate | 5.0% | 4.5% | 5.0% | 5.0% | 10.5% |
| Sodium cocoamphoacetate | 5% | 5.5% | | 5% | |
| Cocoamidopropylbetaine | | | 4.5% | | 4.5% |
| Sodium lauroyl sarcosinate | | | | | 1.6% |
| PEG-40 hydrogenated castor oil | 0.5% | 0.5% | 0.5% | 0.5% | 0.5% |
| PEG-7 glyceryl cocoate | 1.0% | 1.5% | 0.75% | 1.0% | |
| PEG-4 rapeseed amide | | | | | 4.0% |
| PEG-9 cocoglyceride | | | | | 1.6% |
| Glycerol | 1.5% | 1.0% | 2% | 1.5% | |
| PEG-200 hydrogenated glyceryl palmitate | | 0.5% | | | 1.5% |
| PEG-90 glyceryl isostearate | | 0.5% | | | |
| Laureth-2 | | 0.1% | | | |
| PEG-120 methyl glucose dioleate | 0.5% | | 0.3% | 0.5% | |
| Hydroxypropyl guar hydroxy- | | | | | 0.3% |
| propyltrimonium chloride | | | | | |
| Sodium chloride | | | 0.2% | | |
| Trisodium EDTA | | 0.2% | | | |
| Tetrasodium iminodisuccinate | | | 1% | | |
| Polyquaternium-10 | 0.1% | | | 0.1% | |
| Benzophenone-4 | | 0.1% | | | |
| Glycol distearate | | | 0.3% | | |
| Glycerol | | | 0.2% | | |
| Laureth-4 | | | 0.2% | | |
| Styrene/acrylate copolymer | | | | 2.5% | |
| Preservatives | q.s. | q.s. | q.s. | q.s. | q.s. |
| Dyes | q.s. | q.s. | q.s. | q.s. | q.s. |
| Citric acid | q.s. | q.s. | q.s. | q.s. | q.s. |
| Perfume | q.s. | q.s. | q.s. | q.s. | q.s. |
| Water | ad 100 | ad 100 | ad 100 | ad 100 | ad 100 |

4) Oil-containing products

| | 1 | 2 | 3 | 4 | 5 |
|---|---|---|---|---|---|
| Paraffin oil | 46% | 14% | 20% | 20% | 25% |
| Soya oil | 24.3% | 36% | 20% | 20% | 25% |
| Sunflower oil | | | | | |
| Wheatgerm oil | | | | | |
| Castor oil | | | | | |
| Sodium lauryl | 7.4% | 12.3% | 11% | 11% | 11% |
| ether sulphate | | | | | |
| MIPA laureth | | | | | |
| sulphate | | | | | |
| Laureth-4 | | | | | |
| Cocamide DEA | | | | | |
| TIPA laureth | | | | | |
| sulphate | | | | | |
| Acrylates/C10-C30 | — | — | 1% | 1% | 0.8% |
| alkyl acrylate | | | | | |
| crosspolymer | | | | | |
| PEG-40 sorbitan | | | | | |
| perisostearate | | | | | |
| Propylene glycol | | | | | |
| Benzophenone-3 | | | | | |
| BHT | | | | | |
| Poloxamer 101 | | | | | |
| Sodium hydroxide | — | — | 0.2% | 0.2% | 0.2% |
| Preservatives | q.s. | q.s. | q.s. | q.s. | q.s. |
| Dyes | q.s. | q.s. | q.s. | q.s. | q.s. |
| Perfume | q.s. | q.s. | q.s. | q.s. | q.s. |
| Water | ad | ad | ad | ad | ad |
| | 100 | 100 | 100 | 100 | 100 |

5) Conditioner shampoo with pearlescence
(and opacifier formula 5)

| | 1 | 2 | 3 | 4 | 5 |
|---|---|---|---|---|---|
| Sodium lauryl ether | 9 | 9 | 9 | 9 | 9 |
| sulphate | | | | | |
| Cocoamidopropylbetaine | 4 | 4 | 4 | 4 | 4 |
| Disodium PEG-5 lauryl | 3 | 3 | 3 | 3 | 3 |
| citrate sulphosuccinate | | | | | |
| Thickener | 0.1 | 0.1 | 0.1 | 0.2 | 0.3 |
| Polyquaternium-10 | 0.3 | 0.1 | 0.1 | 0.3 | — |
| Guar hydroxypropyl- | — | — | 0.1 | 0.2 | 0.2 |
| trimonium chloride | | | | | |
| Pearlescence | 1.5 | 3 | 4 | 2 | 2.5 |
| Opacifier | — | — | — | — | 0.5 |
| Iminodisuccinic acid | 0.1 | 0.2 | 0.1 | 0.5 | 0.5 |
| PEG-40 hydrogenated | 0.2 | 0.2 | 0.2 | 0.2 | 0.2 |
| castor oil | | | | | |
| Sodium salicylate | 0.4 | 0.4 | 0.4 | 0.4 | 0.4 |
| Sodium benzoate | 0.4 | 0.4 | 0.4 | 0.4 | 0.4 |
| Sodium chloride | 0.9 | 1.0 | 1.2 | — | — |
| Citric acid | q.s. | q.s. | q.s. | q.s. | q.s. |
| Perfume | q.s. | q.s. | q.s. | q.s. | q.s. |
| Water | ad 100 | ad 100 | ad 100 | ad 100 | ad 100 |

6) Clear conditioning shampoo

| | 1 | 2 | 3 | 4 | 5 |
|---|---|---|---|---|---|
| Sodium lauryl ether | 10 | 9 | 3.5 | 3.5 | 0.5 |
| sulphate | | | | | |
| Sodium myreth sulphate | — | — | 3.5 | 3.5 | 3.0 |
| Cocoamidopropylbetaine | 4 | 4.5 | 3 | — | — |
| Sodium cocoampho- | — | — | — | 2.5 | — |
| acetate | | | | | |
| Disodium PEG-5 lauryl | — | — | — | — | 2.5 |
| citrate sulphosuccinate | | | | | |
| Decyl glucoside | — | — | — | — | 4.5 |
| Thickener | 0.1 | 0.1 | 0.1 | 0.1 | 0.5 |
| Polyquaternium-10 | 0.1 | 0.1 | 0.05 | 0.25 | 0.2 |
| Guar hydroxypropyl- | — | 0.1 | — | — | 0.2 |
| trimonium chloride | | | | | |
| Hydrolysed silk protein | — | — | — | — | 0.3 |
| Iminodisuccinic acid | 0.1 | 0.1 | 0.2 | — | — |
| PEG-40 hydrogenated | 0.2 | 0.2 | 0.2 | 0.1 | 0.2 |
| castor oil | | | | | |
| Sodium salicylate | — | — | 0.4 | — | |
| Sodium benzoate | 0.5 | 0.5 | 0.4 | 0.4 | 0.4 |
| Benzophenone-4 | — | — | 0.1 | — | — |
| Citric acid | q.s. | q.s. | q.s. | q.s. | q.s. |
| Perfume | q.s. | q.s. | q.s. | q.s. | q.s. |
| Water | ad 100 | ad 100 | ad 100 | ad 100 | ad 100 |

7) Mild baby shampoo

| | 1 | 2 | 3 | 4 | 5 |
|---|---|---|---|---|---|
| Sodium myristyl | 4 | 4 | 5 | 5 | 4 |
| ether sulphate | | | | | |
| Decyl glucosides | 4 | 4 | 4 | 4 | 4 |
| Disodium PEG-5 | 4 | 4 | 3 | 5 | 5 |
| lauryl citrate | | | | | |
| sulphosuccinate | | | | | |
| PEG-80 sorbitan | 2 | 1 | 1 | — | 0.5 |
| laurate | | | | | |
| Thickener | 0.1 | 0.1 | 0.1 | 0.2 | 0.3 |
| Polyquaternium-10 | 0.3 | 0.1 | 0.1 | 0.3 | — |
| Guar hydroxypropyl- | — | — | 0.1 | 0.2 | 0.2 |
| trimonium chloride | | | | | |
| Pearlescence | — | — | 4 | 2 | 2.5 |
| Opacifier | — | — | — | — | 0.5 |
| Iminodisuccinic acid | — | 0.2 | 0.1 | 0.5 | 0.5 |
| PEG-40 hydrogenated | 0.2 | 0.2 | 0.2 | 0.2 | 0.2 |
| castor oil | | | | | |
| Sodium salicylate | 0.4 | 0.4 | 0.4 | 0.4 | 0.4 |
| Sodium benzoate | 0.4 | 0.4 | 0.4 | 0.4 | 0.4 |
| Sodium chloride | 0.9 | 1.0 | 1.2 | — | — |
| Citric acid | q.s. | q.s. | q.s. | q.s. | q.s. |
| Perfume | q.s. | q.s. | q.s. | q.s. | q.s. |
| Water | ad 100 | ad 100 | ad 100 | ad 100 | ad 100 |

8) Leave-on conditioner

| | 1 | 2 | 3 | 4 |
|---|---|---|---|---|
| Laureth-4 | 0.6 | 0.4 | 0.5 | 0.5 |
| Coconut fatty acid ethylhexyl ester | 0.9 | 0.8 | 0.8 | 1 |
| C12-13 alkyl lactate | 0.5 | 0.7 | 2.5 | 1 |
| Acrylate/C10-30 alkyl acrylate | 0.9 | 0.7 | 1.0 | 0.8 |
| crosspolymer | | | | |
| Hydroxypropyl guar hydroxyl- | 0.1 | 0.3 | 0.2 | 0.2 |
| propyltrimonium chloride | | | | |
| PVP/VA copolymer | 4 | 4 | 3 | 5 |
| Propylene glycol | 3 | 5 | 6 | 7 |
| Palmitamidopropyltrimonium | 0.4 | 0.3 | 0.5 | 0.5 |
| chloride | | | | |
| Perfume, solubility promoter, | 2 | 2 | 2 | 2 |
| preservative, complexing agent, | | | | |
| buffer | | | | |
| Water | ad 100 | ad 100 | ad 100 | ad 100 |

9) Styling gel

| | 1 | 2 |
|---|---|---|
| PVP/VA copolymer | 5.0 | 5.0 |
| Carbomer | 0.7 | 1.0 |
| Perfume | 0.3 | 0.2 |
| PEG-40 hydrogenated castor oil | 0.5 | 0.3 |
| NaOH | q.s. | q.s. |
| Glycerol | 0.5 | 0.2 |
| Ethanol | 10.0 | — |
| Water | ad 100 | ad 100 |

10) Styling emulsion
Viscosities: greater than 300 000 mPas

| | 1 | 2 | 3 | 4 |
|---|---|---|---|---|
| Paraffin oil | 5.0 | 5.0 | 5.0 | 5.0 |
| Sorbitan stearate | 3.0 | 2.0 | 3.0 | 2.0 |
| Oleth-15 | 1.5 | 2.2 | 1.5 | 2.2 |
| PVP | 1.5 | 1.3 | | |
| Polyquaternium-46 | — | — | 4.0 | 3.5 |
| Glycerol | 5.0 | 6.0 | 5.0 | 6.0 |
| Preservative | 0.4 | 0.4 | 0.4 | 0.4 |
| Perfume | 0.2 | 0.2 | 0.2 | 0.2 |
| Water | ad 100 | ad 100 | ad 100 | ad 100 |

11) O/W emulsions

| | 1 | 2 | 3 | 4 | 5 | 6 | 7 |
|---|---|---|---|---|---|---|---|
| PEG-40 castor oil, sodium | | | | | | | 2.50 |
| cetearyl sulphate cetearyl alcohol | | | | | | | |
| Glycerol monostearate (SE) | 1.00 | 2.00 | 3.00 | 1.00 | | 1.50 | |
| Glyceryl stearate citrate | | | | | 2.00 | | |
| Stearic acid | 3.00 | | 2.50 | 2.00 | | | |
| PEG-40 stearate | | 2.00 | | | | 2.00 | |
| PEG-100 stearate | | | 0.75 | | | | |
| Lauryl methicone copolyol | | | | 0.75 | | 0.50 | |
| Sorbitan stearate | | | 0.75 | | | | |
| Cetyl phosphate | | | 0.75 | | | | |
| Stearyl alcohol | | | 3.00 | | 2.00 | 2.00 | 0.50 |
| Cetyl alcohol | 1.00 | 2.00 | | | 0.50 | | 2.00 |
| UVASorb ® K2A | | | | 4.00 | | 5.00 | |
| Uvinul ® A Plus | 2.50 | | | 0.25 | 1.00 | 0.50 | |
| Butylmethoxydibenzoylmethane | | | | | | | 4.00 |
| 4-Methylbenzylidenecamphor | | | 3.00 | | | | |
| Bisethylhexyloxyphenol | 1.00 | | | | | 1.00 | 0.50 |
| methoxyphenyltriazine | | | | | | | |
| Disodium phenyldibenzimidazole- | | | | 1.00 | | 2.00 | |
| tetrasulphonate | | | | | | | |
| Phenylbenzimidazolesulphonic acid | | | | | | | 3.00 |
| Ethylhexyl triazone | | | | 2.00 | | 2.00 | |
| Diethylhexylbutamidotriazone | 2.00 | | | | | | |
| Ethylhexyl methoxycinnamate | 3.50 | | | 10.00 | | | |
| Octocrylene | | | | 5.00 | 9.00 | 7.50 | 2.50 |
| Methylenebisbenzotriazolyl | | | 2.00 | | 3.00 | | |
| tetramethylbutylphenol | | | | | | | |
| Ethylhexyl salicylate | | 0.50 | 3.00 | | | | 5.00 |
| Drometrizole trisiloxane | | | 0.50 | | | 1.00 | |
| Terephthalidenedicamphorsulphonic acid | | | | | | 2.00 | |
| Dimethylcodiethyl benzalmalonate | | | | | | 3.00 | |
| Titanium dioxide T 805 | 2.00 | | | | 1.00 | 0.50 | |
| Titanium dioxide MT-100Z | | | | 3.00 | 1.00 | | |
| Zinc oxide Z-Cote HP1 | | | | | | | |
| C₁₂₋₁₅ alkyl benzoate | 2.50 | | | | | 7.00 | 5.00 |
| Dicaprylyl ether | | | 3.50 | | 2.00 | | |
| Caprylic/capric triglyceride | | | | | | | |
| Paraffin oil | | 6.00 | | | | | |
| Butylene glycol dicaprylate/dicaprate | | | | 5.00 | 3.00 | | |
| Cetearyl isononanoate | 4.00 | | | | | 2.00 | 2.00 |
| Dimethicone | 0.50 | 3.00 | 1.00 | | 2.00 | | |
| Cyclomethicone | | 3.00 | | 4.50 | | | 0.50 |
| Dimethicone/vinyldimethicone crosspolymer | 4.00 | | | | | | 0.50 |
| PVP hexadecene copolymer | | | | 0.50 | 1.00 | | 1.00 |
| Glycerol | 7.50 | 10.00 | | 7.50 | 5.00 | | 20.00 |
| Xanthan gum | | 0.20 | 0.05 | | | | 0.30 |
| Butylene glycol | 5.00 | | | | | 7.00 | |
| Ascorbic acid | | | | | | 3.50 | |
| Tocopherol | 0.20 | | | | | | |
| Taurine | 1.00 | | | | | | |
| Vitamin E acetate | | 0.40 | 0.25 | 0.50 | 0.75 | | 1.00 |
| Retinol | | | | | 0.05 | | |
| Dioic acid (octadecenedicarboxylic acid) | | | | 0.20 | | 0.25 | |
| Pyridoxine | | 0.5 | | | | | |
| Fucogel ® 1000 | | | 1.50 | | | 5.00 | |
| Dihydroxyacetone | | 5.00 | | | | | |
| DMDM hydantoin | 0.60 | | 0.40 | 0.20 | | | |
| Methylparaben | | 0.10 | 0.25 | | 0.50 | | |
| Phenoxyethanol | 0.40 | 0.50 | | 0.40 | 0.50 | | 0.60 |
| EDTA | 0.20 | | 0.35 | 0.50 | 0.02 | | 0.03 |
| Ethanol | 2.00 | | 1.50 | | 3.00 | 5.00 | 1.00 |
| Insekt repellent 3535 | | | 5.00 | | | | |
| Perfume | 0.20 | 0.20 | | | | 0.30 | 0.40 |
| Water | ad | ad | ad | ad | ad | ad | ad |
| | 100 | 100 | 100 | 100 | 100 | 100 | 100 |
| Neutralizing agent (sodium | qs | qs | qs | qs | qs | qs | qs |
| hydroxide, potassium hydroxide) | | | | | | | |
| pH | 6.0-7.5 | 4.5-7.0 | 6.5-8.5 | 5.0-7.0 | 6.0-8.0 | 4.0-6.0 | 5.0-7.5 |

| | 8 | 9 | 10 | 11 | 12 |
|---|---|---|---|---|---|
| Glycerol monostearate (self-emulsifying) | | | | 1.00 | |
| Glyceryl stearate citrate | 2.00 | 2.00 | 1.50 | | |
| Polyglyceryl-3 methylglucose distearate | | | | | 4.50 |
| Stearyl alcohol | 2.00 | 2.00 | | | |
| Cetyl alcohol | | | 2.00 | | 4.50 |
| UVASorb ® K2A | | | | | |
| Uvinul ® A Plus | | | | | |
| Bisethylhexyloxyphenol methoxyphenyltriazine | 2.00 | 2.00 | 1.50 | | |
| Disodium phenyldibenzimidazoletetrasulphonate | | | | | |
| Ethylhexyltriazone | | | | | |
| Diethylhexylbutamidotriazone | | 1.00 | 2.00 | | |
| Ethylhexyl methoxycinnamate | 2.00 | 6.00 | 5.00 | | |
| Octocrylene | 2.00 | 9.00 | | | |
| Methylenebisbenzotriazolyltetramethylbutylphenol | | | | | |
| Ethylhexyl salicylate | | | | | |
| Drometrizol trisiloxane | | | | | |
| Titanium dioxide T 805 | | 3.00 | 2.00 | | |
| C₁₂₋₁₅ alkyl benzoate | | | 3.00 | 1.00 | 1.00 |
| Hydrogenated coconut fatty acid glyceride | 1.00 | 1.00 | 3.00 | | |
| Dicaprylyl ether | 5.00 | 2.00 | 6.00 | | |
| Octyldodecanol | 6.00 | 5.00 | 4.00 | 3.00 | 4.00 |
| Butylene glycol dicaprylate/dicaprate | 5.00 | 2.00 | | | |
| Caprylic/capric triglyceride | | | | 2.00 | 5.50 |
| Dimethicone | | | 2.00 | | |
| Cyclomethicone | 2.00 | 1.00 | | 3.00 | |
| Sorbitol | | | | 2.50 | |
| Acrylate/C10-30 alkyl acrylate crosspolymer | 0.10 | 0.10 | 0.05 | | |
| PVP hexadecane copolymer | 0.50 | 0.50 | | | |
| Glycerol | 8.00 | 6.00 | 5.00 | 3.00 | 3.00 |
| Xanthan gum | 0.40 | 0.40 | 0.25 | 0.30 | 0.10 |
| Butylene glycol | | | 3.00 | 3.00 | |
| Linoleic acid | 1.00 | | | | |
| Evening primrose oil | | 1.00 | | | |
| Genistein | 0.05 | | | | |
| Silymarin | | 0.1 | | | |
| Phosphatidylcholine | | | | 0.06 | |
| Silybin | | | | 0.03 | |
| Carnitine | | | 0.5 | | |
| Vitamin E acetate | 0.50 | | 0.30 | 0.40 | 0.40 |
| Dihydroxyacetone | | | | 5.00 | 4.00 |
| DMDM hydantoin | 0.60 | 0.60 | 0.50 | | |
| Methylparaben | | | | 0.30 | 0.30 |
| Phenoxyethanol | 0.40 | 0.40 | 0.35 | 0.50 | 0.50 |
| EDTA | 1.00 | 1.00 | 1.00 | | 1.00 |
| Ethanol | | | 3.00 | 3.00 | |
| Insekt repellent 3535 | | | | | |
| Perfume | 0.40 | 0.40 | 0.40 | 0.40 | 0.40 |
| Water | ad 100 | ad 100 | ad 100 | ad 100 | ad 100 |
| Neutralizing agent (sodium hydroxide, potassium hydroxide) | qs | qs | qs | qs | qs |
| pH | 5.0-7.0 | 5.0-7.0 | 5.0-7.0 | 5.0-7.0 | 5.0-7.0 |

| | 13 | 14 | 15 | 16 | 17 | 18 | 19 |
|---|---|---|---|---|---|---|---|
| Glyceryl stearate, ceteareth-12, ceteareth-20, | | | | | | | 1.50 |
| cetearyl alcohol, cetyl palmitate | | | | | | | |
| Glycerol monostearate (SE) | | 4.00 | | | | | |
| Glyceryl stearate citrate | 2.00 | | | | | | |
| Polyglyceryl-3 methylglucose distearate | | | | | 2.00 | | |
| Cetearyl glucoside & cetearyl alcohol | | | | | | 2.00 | |
| Triceteareth-4 phosphate | | | 1.20 | | | | |
| Trilaureth-4 phosphate | | | | 2.00 | | | |
| Ceteareth-6 | | | 0.50 | 0.50 | | | |
| Sorbitan stearate | | | 0.75 | 1.00 | 1.00 | | |
| Cetyl phosphate | | | | | 2.00 | | |
| Stearyl alcohol | | 2.50 | 3.00 | | | | 1.50 |
| Cetyl alcohol | 2.50 | 1.00 | | | 0.50 | 2.00 | 2.00 |
| UVASorb ® K2A | 1.00 | | | 4.00 | | 5.00 | |
| Uvinul ® A Plus | 3.00 | 2.50 | 0.50 | 0.25 | 1.00 | 0.50 | |
| Butylmethoxydibenzoylmethane | | | | | | | 4.50 |
| Bisethylhexyloxyphenol methoxyphenyl- | | 2.00 | | | | 1.00 | 0.50 |
| triazine | | | | | | | |
| Disodium phenyldibenzimidazole- | | | | 1.00 | | 2.00 | |
| tetrasulphonate | | | | | | | |
| Phenylbenzimidazolesulphonic acid | | | | | 3.00 | | |
| Ethylhexyltriazone | 2.00 | | | 2.00 | | 2.00 | |
| Diethylhexylbutamidotriazone | | 2.00 | | | | | |
| Ethylhexyl methoxycinnamate | | 3.50 | | 10.00 | | | |
| Octocrylene | | | | 5.00 | 9.00 | 7.50 | 2.50 |
| Methylenebisbenzotriazolyltetramethyl- | | | 2.00 | | 3.00 | | |
| butylphenol | | | | | | | |
| Ethylhexyl salicylate | | | | | | | 5.00 |
| Drometrizole trisiloxane | | | 0.50 | | | 1.00 | |
| Terephthalidenedicamphorsulphonic acid | | 3.00 | | | | | |
| Dimethylcodiethyl benzalmalonate | | | 5.00 | | | | |
| Titanium dioxide MT-100Z | 1.00 | | | 3.00 | 1.00 | | |
| Zinc oxide Z-cote HP1 | | | | | | 3.00 | |
| Corapan TQ ® | | | | | | | 6.00 |
| C₁₂₋₁₅ alkyl benzoate | | 2.50 | | | | 7.00 | 5.00 |
| Dicaprylyl ether | | | 3.50 | | 2.00 | | |
| Butylene glycol dicaprylate/dicaprate | 5.00 | | | 5.00 | 3.00 | | |
| Cetearyl isononanoate | | 4.00 | | | | 2.00 | 2.00 |
| Dimethicone | | 0.50 | 1.00 | | 2.00 | | |
| Cyclomethicone | 2.00 | | | 4.50 | | | 0.50 |
| Dimethicone/vinyldimethicone crosspolymer | | 4.00 | | | | | 0.50 |
| PVP hexadecene copolymer | 0.50 | | | 0.50 | 1.00 | | 1.00 |
| Glycerol | 3.00 | 7.50 | | 7.50 | 5.00 | | 20.00 |
| Xanthan gum | 0.15 | | 0.05 | | | | 0.30 |
| Butylene glycol | 7.00 | 5.00 | | | | 7.00 | |
| Liquorice extract | | | | | | 0.5 | |
| Licochalcone | | | 0.05 | | | | |
| Curcumin | 0.05 | | | | | | |
| beta-Carotene | | | | 0.1 | | | |
| Ceramide III | | | | | 0.3 | | |
| Isoserinol | | 1.0 | | | | | |
| Vitamin E acetate | 0.50 | | 0.25 | 0.50 | 0.75 | | 1.00 |
| Dioic acid | 0.25 | | | 0.20 | | 0.25 | |
| Fucogel ® 1000 | | | 1.50 | | | 5.00 | |
| DMDM hydantoin | | 0.60 | 0.40 | 0.20 | | | |
| Methylparaben | 0.15 | | 0.25 | | 0.50 | | |
| Phenoxyethanol | 1.00 | 0.40 | | 0.40 | 0.50 | | 0.60 |
| EDTA | | 0.20 | 0.35 | 0.50 | 0.02 | | 0.03 |
| Alcohol | | 2.00 | 1.50 | | 3.00 | 5.00 | 1.00 |
| Insect repellent 3535 | | | 5.00 | | | | |
| Sea salt | 0.1 | | | | | | |
| Perfume | 0.20 | 0.20 | | | | 0.30 | 0.40 |
| Water | ad | ad | ad | ad | ad | ad | ad |
| | 100 | 100 | 100 | 100 | 100 | 100 | 100 |
| Neutralizing agent (NaOH, KOH) | qs | qs | qs | qs | qs | qs | qs |
| pH | 4.5-6.0 | 4.5-7.0 | 5.5-7.5 | 5.0-7.0 | 5.5-7.5 | 4.0-7.0 | 4.0-7.5 |

12) Foam-like O/W emulsions:

| | 1 | | 2 | |
|---|---|---|---|---|
| | % by wt. | % by vol. | % by wt. | % by vol. |
| Stearic acid | 5.00 | | 1.00 | |
| Cetyl alcohol | 5.50 | | | |
| Cetylstearyl alcohol | | | 2.00 | |
| PEG-40 stearate | 8.50 | | | |
| PEG-20 stearate | | | 1.00 | |
| Caprylic/capric | 4.00 | | 2.00 | |
| triglyceride | | | | |
| C12-15 alkyl benzoate | 10.00 | | 15.50 | |
| Cyclomethicone | 4.00 | | | |
| Dimethicone | | | 0.50 | |
| Octyl isostearate | | | 5.00 | |
| Myristyl myristate | | | 2.00 | |
| Ceresine | 1.50 | | | |
| Glycerol | 5.00 | | 10.00 | |
| UVASorb ® K2A | 2.00 | | | |
| Uvinul A Plus ® | 2.00 | | 1.50 | |
| Terephthalidenedicam- | 0.50 | | | |
| phorsulphonic acid | | | | |
| Drometrizole trisiloxane | 1.50 | | | |
| Ethylhexyl | 5.00 | | 4.00 | |
| methoxycinnamate | | | | |
| Ethylhexyltriazone | | | 3.00 | |
| Octocrylene | 5.00 | | | |
| Titanium dioxide | 1.00 | | | |
| Uvinul T 805 | | | | |
| BHT | | | 0.02 | |
| Na₂H₂EDTA | 0.50 | | 0.10 | |
| Perfume, preservative, | qs | | qs | |
| Dyes, etc. | qs | | qs | |
| Potassium hydroxide | qs | | qs | |
| Water | ad 100.00 | | ad 100.00 | |
| | pH adjusted | | pH adjusted | |
| | to 6.5-7.5 | | to 5.0-6.0 | |
| Emulsion 1 | | 70 | | |
| Emulsion 2 | | | | 35 |
| Gas (nitrogen, oxygen | | 30 | | |
| or carbon dioxide) | | | | |
| Gas (air) | | | | 65 |

| | Emulsion | | |
|---|---|---|---|
| | 3 | 4 | 5 |
| Stearic acid | 2.00 | 2.00 | |
| Palmitic acid | | | 1.50 |
| Cetyl alcohol | 2.50 | 2.00 | |
| Stearyl alcohol | | | 3.00 |
| PEG-100 stearate | | | 3.50 |
| PEG-40 stearate | | 2.00 | |
| PEG-20 stearate | 3.00 | | |
| Sorbitan stearate | | 0.80 | |
| C12-15 alkyl benzoate | 5.00 | | |
| C12-13 alkyl tartrate | | | 7.00 |
| Butylene glycol | | 6.00 | |
| dicaprylate/dicaprate | | | |
| Dicaprylyl ether | | | 2.00 |
| Cyclomethicone | | 2.00 | 3.00 |
| Butylene glycol | 1.00 | | |
| Isohexadecane | 2.00 | | |
| Methylpropanediol | | | |
| Propylene glycol | | | 5.00 |
| Glycerol | 5.00 | 7.00 | |
| UVASorb ® K2A | | | 2.00 |
| Uvinul A Plus ® | 2.00 | | |
| NeoHeliopan ® AP | | | |
| Phenylbenzimidazolesulphonic | | | |
| acid | | | |
| Ethylhexyl methoxycinnamate | | | |
| Ethylhexyltriazone | 2.00 | 2.00 | 2.00 |
| Octocrylene | 2.00 | | |
| Bisethylhexyloxyphenol | | 3.00 | 3.00 |
| methoxyphenoltriazine | | | |
| Vitamin E acetate | | 0.5 | |
| BHT | | | 0.10 |
| Na₂H₂EDTA | 0.50 | | |
| Perfume, preservative | q.s. | q.s. | q.s. |
| Dyes, etc. | q.s. | q.s. | q.s. |
| Sodium hydroxide | q.s. | | q.s. |
| Potassium hydroxide | | q.s. | |
| Water | ad 100.0 | ad 100.0 | ad 100.0 |

| | Emulsion | | | |
|---|---|---|---|---|
| | 6 | 7 | 8 | 9 |
| Stearic acid | 1.50 | | | |
| Palmitic acid | | | 3.00 | 3.00 |
| Cetyl alcohol | | 3.00 | | |
| Cetylstearyl alcohol | | | 2.00 | 2.00 |
| Stearyl alcohol | 3.00 | | | |
| PEG-100 stearate | | 4.00 | | |
| PEG-40 stearate | 3.00 | | | |
| PEG-20 stearate | | | 3.00 | 3.00 |
| Sorbitan stearate | 1.00 | | | |
| Tridecyl trimellitate | | 5.00 | | |
| C12-15 alkyl benzoate | | | 3.00 | 3.00 |
| Butylene glycol | 8.00 | | | |
| dicaprylate/dicaprate | | | | |
| Octyldodecanol | | 2.00 | | |
| Coconut fatty acid | | | | 2.00 |
| glyceride | | | | |
| Dicaprylyl ether | | | 2.00 | 2.00 |
| Cyclomethicone | | | | |
| Dimethicone | 1.00 | | 2.00 | 2.00 |
| Isohexadecane | | 3.00 | | |
| Methylpropanediol | | 4.00 | | |
| Propylene glycol | | | | |
| Glycerol | 5.00 | | 6.00 | 6.00 |
| NeoHeliopan ® AP | | 2.00 | | |
| Phenylbenzimidazole- | 1.00 | 4.00 | 1.00 | 1.00 |
| sulphonic acid | | | | |
| Ethylhexyl | 5.00 | | 4.00 | 4.00 |
| methoxycinnamate | | | | |
| Ethylhexyltriazone | | | | |
| Diethylhexylbutamido- | 1.00 | | | |
| triazone | | | | |
| Butylmethoxydibenzoyl- | 2.50 | | 2.00 | 2.00 |
| methane | | | | |
| Bisethylhexyloxyphenol | 2.00 | | | |
| methoxyphenyltriazine | | | | |
| Vitamin E acetate | 0.20 | | 0.30 | 0.30 |
| BHT | | 0.05 | | |
| Na₂H₂EDTA | | | 0.40 | 0.40 |
| Perfume, preservative | q.s. | q.s. | q.s. | q.s. |
| Dyes, etc. | q.s. | q.s. | q.s. | q.s. |
| Sodium hydroxide | q.s. | q.s. | q.s. | q.s. |
| Potassium hydroxide | | | | q.s. |
| Water | ad 100.0 | ad 100.0 | ad 100.0 | ad 100.0 |

To prepare the foam, 80-97% by volume of emulsion I are foamed with 3-20% by volume of a suitable gas (e.g. propane/butane, compressed air, nitrogen).

13) W/O emulsions

| | 1 | 2 | 3 | 4 | 5 |
|---|---|---|---|---|---|
| Cetyldimethicone | 4.00 | | | 2.50 | 3.00 |
| copolyol | | | | | |
| Polyglyceryl-2 | | | 3.00 | | 1.00 |
| dipolyhydroxy- | | | | | |
| stearate | | | | | |
| Isostearyl di- | | | 0.75 | | 0.30 |
| glyceryl succinate | | | | | |
| Laurylmethicone | | | | 2.00 | |
| copolyol | | | | | |
| Polysorbate-65 | | | 2.00 | | 1.50 |
| PEG-100 stearate | | | | 1.20 | 0.70 |
| Cetearyl sulphate | | | 0.25 | | 1.00 |
| Dimethicone | | 4.00 | | | 2.00 |
| Cyclomethicone | 12.00 | 20.00 | | 30.00 | 15.00 |
| UVASorb ® K2A | | | | 0.50 | |
| Uvinul ® A Plus | | 2.00 | 0.50 | 4.00 | 0.25 |
| Bisethylhexyloxy- | 1.00 | | | 0.50 | |
| phenol methoxy- | | | | | |
| phenyltriazine | | | | | |
| Disodium phenyl- | | 1.50 | | | 2.00 |
| dibenzimidazole | | | | | |
| tetrasulphonate | | | | | |
| Drometrizole | | | | 1.00 | |
| trisiloxane | | | | | |
| 4-Methylbenzyl- | 4.00 | | | | |
| idenecamphor | | | | | |
| Methylenebisbenzo- | | | | | 3.00 |
| triazolyltetra- | | | | | |
| methylbutyphenol | | | | | |
| Ethylhexyl | 3.00 | 4.00 | | | 10.00 |
| methoxycinnamate | | | | | |
| Ethylhexyl | | | 5.00 | | 3.50 |
| salicylate | | | | | |
| Octocrylene | | 5.00 | | 4.00 | |
| Diethylhexyl- | | 1.00 | | | 6.50 |
| butamidotriazone | | | | | |
| Ethylhexyltriazone | 3.00 | | | | 4.00 |
| Titanium dioxide | | 0.50 | 1.00 | 1.50 | 0.50 |
| MT-100 Z | | | | | |
| Zinc oxide Z-Cote | 2.00 | | | | 4.00 |
| Dicaprylyl | 5.00 | | 15.00 | | 4.00 |
| carbonate | | | | | |
| Dihexyl carbonate | | 10.00 | | | |
| C12-15 alkylbenzoate | 7.00 | | 10.00 | | |
| Mineral oil | 10.00 | | | | 6.00 |
| Coconut fatty acid | | 2.00 | | 5.00 | |
| glyceride | | | | | |
| PVP hexadecene | | 0.75 | | | 0.40 |
| copolymer | | | | | |
| Glycerol | 5.00 | 12.50 | | 5.00 | 15.50 |
| Sorbitol | 5.00 | | 10.00 | | |
| α-Glucosylrutin | | | | | 0.15 |
| EDTA | | 0.15 | 0.03 | | 0.15 |
| Glycine soya | 0.75 | | | 1.50 | |
| Magnesium sulphate | 0.75 | 1.00 | | 0.45 | 1.00 |
| DMDM hydantoin | | 0.05 | | | 0.10 |
| Phenoxyethanol | 1.00 | 0.75 | 0.50 | | 1.00 |
| Alcohol | 2.00 | | | 5.00 | 1.00 |
| Dye, oil-soluble | 0.02 | | | | |
| Perfume | 0.30 | 0.45 | 0.35 | | 0.15 |
| Water | ad 100 | ad 100 | ad 100 | ad 100 | ad 100 |

14) W/O emulsions (creams and lotions)

| | 1 | 2 | 3 | 4 | 5 | 6 |
|---|---|---|---|---|---|---|
| Cetyldimethicone copolyol | | | | | 4.00 | |
| Polyglyceryl-2 dipolyhydroxystearate | 5.00 | 4.50 | | | | 4.50 |
| Polyglyceryl-3-diisostearate | 1.75 | 1.50 | | | | |
| PEG-30 dipolyhydroxystearate | | | 3.00 | 5.00 | | |
| Bisethylhexyloxyphenol | | | 3.00 | 1.50 | | |
| methoxyphenyltriazine | | | | | | |
| Butylmethoxydibenzoylmethane | | | 4.00 | | | |
| UVASorb ® K2A | | | | 2.00 | 2.50 | |
| Uvinul ® A Plus | 3.00 | 1.00 | | 3.00 | 0.25 | 2.50 |
| Phenylbenzimidazolesulphonic acid | | 4.00 | | | 2.00 | 0.50 |
| Ethylhexyl methoxycinnamate | | 8.00 | | | 5.00 | 4.00 |
| Diethylhexylbutamidotriazone | 3.00 | 1.00 | | 1.00 | | 3.00 |
| Ethylhexyltriazone | | | 4.00 | 2.00 | 4.00 | |
| Octocrylene | 7.00 | | | | | 2.50 |
| Drometrizole trisiloxane | | | | | | |
| Titanium dioxide Uvinul ® T 805 | 2.00 | 1.00 | 5.00 | | | |
| Titanium dioxide MT-100 TV | | | | | | 2.00 |
| Zinc oxide Z-Cote ® HP1 | 2.50 | | | 3.00 | | |
| Corapan TQ ® | | | 6.00 | | | |
| Mineral oil | | | 6.00 | 5.00 | | 8.00 |
| Coconut fatty acid glyceride | 4.00 | 6.50 | | 5.00 | | |
| C12-15 alkyl benzoate | | | 9.00 | 8.00 | 9.00 | |
| Dicaprylyl ether | 10.00 | | | | | 7.00 |
| Butylene glycol dicaprylate/dicaprate | | | 9.00 | 7.00 | 8.00 | 4.00 |
| Cyclomethicone | 2.00 | | | | | 2.00 |
| PVP eicosene copolymer | 0.50 | | | | 1.50 | 1.00 |
| Trisodium EDTA | 1.00 | | 1.00 | 0.50 | 0.35 | |
| Ethylhexyloxyglycerol | | 0.30 | | | | 0.50 |
| Methylpropanediol | | | | | | 7.50 |
| Glycerol | 5.00 | 7.50 | 6.00 | 8.00 | 7.50 | 2.50 |
| Butylene glycol | | 2.50 | | | | |
| Glycine soya | | 1.00 | | | | |
| MgSO₄ | 1.00 | 0.50 | 0.30 | 0.30 | 0.50 | |
| Lactic acid & sodium salt of lactic | 1.00 | 0.50 | | | | 0.85 |
| acid | | | | | | |
| Vitamin E | 0.50 | | 0.50 | 1.00 | | 1.00 |
| DMDM hydantoin | | 0.60 | | | 0.20 | |
| Methylparaben | 0.50 | | | | 0.15 | |
| Phenoxyethanol | 0.50 | 0.40 | 0.50 | 0.60 | 1.00 | 0.60 |
| Dihydroxyacetone | | | | | 5.50 | |
| Alcohol | 3.00 | | 2.00 | 3.00 | | 1.00 |
| Perfume | 0.20 | | 0.20 | 0.20 | | 0.20 |
| Water | ad 100 | ad 100 | ad 100 | ad 100 | ad 100 | ad 100 |

15) Hydrodispersions

| | 1 | 2 | 3 | 4 | 5 | 6 |
|---|---|---|---|---|---|---|
| Glyceryl stearate citrate | | 0.40 | | | | |
| Cetyl alcohol | | | | | 2.00 | |
| Sodium carbomer | | | | | 0.30 | |
| Acrylates/C10-30 alkyl acrylate crosspolymer | | | 0.30 | 0.40 | 0.10 | 0.10 |
| Ceteareth-20 | | | 1.00 | | | |
| Xanthan gum | 0.50 | | | 0.15 | | 0.50 |
| Dimethicone/vinyldimethicone crosspolymer | | | | 5.00 | | 3.00 |
| UVASorb ® K2A | | | | | 3.50 | |
| Uvinul ® A Plus | 0.25 | | | 0.50 | 2.00 | 1.50 |
| Butylmethoxydibenzoylmethane | | | 3.50 | | | |
| Bisethylhexyloxyphenol | | 2.00 | | 0.25 | | |
| methoxyphenyltriazine | | | | | | |
| Terephthalidenedicamphorsulphonic acid | | | | | | 0.50 |
| Disodium phenyldibenzimidazoletetra- | 0.75 | | | | | 1.00 |
| sulphonate | | | | | | |
| Phenylbenzimidazolesulphonic acid | | | 2.00 | | | |
| Ethylhexyl methoxycinnamate | | | 7.00 | | 5.00 | 8.00 |
| Methylenebisbenzotriazolyltetramethyl- | | | | | | |
| butylphenol | | | | | | |
| Butylmethoxydibenzoylmethane | | 3.50 | | | | |
| Diethylhexylbutamidotriazone | | | 2.00 | 2.00 | | |
| Ethylhexyltriazone | 4.00 | 3.00 | | | 4.00 | |
| Octocrylene | | | | 10.00 | | 2.50 |
| Titanium dioxide MT-100 Z | 0.50 | 2.00 | 1.00 | 2.00 | 3.00 | 1.00 |
| C₁₂₋₁₅ alkyl benzoate | 2.00 | | 2.50 | | | |
| C18-36 triglyceride fatty acid | | | 1.00 | | | |
| Butylene glycol dicaprylate/dicaprate | 4.00 | | | | 6.00 | |
| Dicaprylyl carbonate | | 3.00 | | | | |
| Dicaprylyl ether | | 2.00 | | | | |
| Cyclomethicone | | | | 7.50 | | |
| Lanolin | | | | | 0.35 | |
| PVP hexadecene copolymer | 0.50 | | 0.50 | | 0.50 | 1.00 |
| Ethylhexyloxyglycerol | | 0.75 | | 1.00 | | 0.50 |
| Glycerol | 10.00 | 5.00 | 5.00 | | 5.00 | 15.00 |
| Butylene glycol | | 7.00 | | | | |
| Glycine soya | | | | 1.00 | | |
| Vitamin E acetate | 0.50 | 0.25 | 0.50 | 0.25 | 0.75 | 1.00 |
| α-Glycosylrutin | | | | | 0.25 | |
| Trisodium EDTA | | 1.00 | 1.00 | 0.10 | 0.20 | |
| Iodopropynyl butylcarbamate | 0.20 | 0.10 | | | | 0.15 |
| Methylparaben | 0.50 | | 0.20 | | 0.15 | |
| Phenoxyethanol | 0.50 | 0.40 | 0.40 | | 1.00 | 0.60 |
| Ethanol | 3.00 | 10.00 | 4.00 | 3.50 | | 1.00 |
| Perfume, dyes | q.s. | q.s. | q.s. | q.s. | q.s. | q.s. |
| Water | ad 100 | ad 100 | ad 100 | ad 100 | ad 100 | ad 100 |
| Neutralizing agent (sodium | q.s. | q.s. | q.s. | q.s. | q.s. | q.s. |
| hydroxide, potassium hydroxide) | | | | | | |
| pH | 4.5-5.5 | 5.0-7.0 | 5.0-7.0 | 5.0-7.0 | 4.0-6.0 | 5.0-7.5 |

16) Gel creams

| | 1 | 2 | 3 | 4 | 5 |
|---|---|---|---|---|---|
| Carbomer | 0.125 | 0.125 | 0.125 | 0.125 | 0.125 |
| Shea butter | | | | 1.00 | |
| Mineral oil | | | | | 6.00 |
| Octyldodecanol | | | | 1.50 | |
| Caprylic/capric | | | 4.00 | | |
| triglyceride | | | | | |
| Dicaprylyl carbonate | | 9.00 | | 1.00 | 3.00 |
| Dimethicone | | | | 0.50 | |
| Cyclomethicone | 9.00 | 2.00 | 3.00 | 2.00 | 1.00 |
| Diazolidinylurea | 0.20 | 0.20 | 0.20 | 0.20 | 0.20 |
| Phenoxyethanol + | 0.50 | 0.50 | 0.50 | 0.50 | 0.50 |
| ethyl-, methyl-, | | | | | |
| propyl-, butyl-, | | | | | |
| isobutylparaben | | | | | |
| Perfume | | | | 0.25 | 0.25 |
| Glyceryl stearate | 1.00 | 1.00 | 1.00 | 1.00 | 1.00 |
| citrate | | | | | |
| Hydrogenated coconut | 1.00 | 1.00 | 1.00 | 1.00 | 1.00 |
| fatty acid glyceride | | | | | |
| Ammonium acryloyldi- | | | | | 0.125 |
| methyl taurate/VP | | | | | |
| copolymer | | | | | |
| Hydroxyethylcellulose | 0.375 | 0.375 | 0.375 | 0.375 | 0.375 |
| Menthol | 0.10 | 0.50 | 1.00 | 0.10 | 0.10 |
| Water + alcohol denat. | | | | 3.00 | |
| Water + Blue 1 | | 0.200 | 0.60 | 0.40 | |
| Water + glycerol | 10.00 | 10.00 | 10.00 | 10.00 | 10.00 |
| Xanthan gum | 0.125 | 0.125 | 0.125 | 0.125 | |
| Water | ad | ad | ad | ad | ad |
| | 100.0 | 100.0 | 100.0 | 100.0 | 100.0 |
| Neutralizing agent | qs | qs | qs | qs | qs |
| (sodium hydroxide, | | | | | |
| potassium hydroxide) | | | | | |
| pH | 4.5-5.5 | 6.5-8.5 | 5.0-7.0 | 4.0-6.0 | 5.0-7.5 |

17) Oil gels

| | 1 | 2 | 3 | 4 | 5 |
|---|---|---|---|---|---|
| Octyldodecanol | 9.00 | 9.00 | | | |
| Caprylic/capric | 9.00 | | 6.00 | | |
| triglyceride | | | | | |
| C12-15-Alkyl benzoate | | | | 5.00 | 8.00 |
| Butylene glycol | | 9.00 | | | 8.00 |
| dicaprylate/dicaprate | | | | | |
| Dicaprylyl ether | 9.00 | | | 4.00 | |
| Dicaprylyl carbonate | | 7.00 | | | |
| Ethyl galactomannan | 3.50 | | | | 4.00 |
| (N-Hance ® AG 200) | | | | | |
| C20-40 fatty acids + | | | | 3.60 | |
| polyethylene | | | | | |
| (Performacid ® 350) | | | | | |
| Hydroxyoctacosanyl | 2.00 | | | | |
| hydroxystearate | | | | | |
| Disteardimonium | 1.00 | | | | 1.00 |
| hectorite | | | | | |
| Cetyl dimethicone | 0.50 | | 4.50 | | |
| Cyclomethicone | | | 15.00 | | 5.00 |
| UVASorb ® K2A | | | | | 1.00 |
| Uvinul ® A Plus | 1.00 | 3.50 | 2.75 | 2.00 | 0.50 |
| Ethylhexyl | 6.00 | | | 10.00 | 3.0 |
| methoxycinnamate | | | | | |
| Octocrylene | 3.50 | | 7.50 | 10.00 | |
| Ethylhexyl salicylate | | 3.50 | | | 4.00 |
| Ethylhexyl triazone | | | 2.00 | | |
| Diethylhexylbutamido- | | 0.50 | | 3.00 | 4.0 |
| triazone | | | | | |
| Polysaccharide | 1.50 | 4.50 | 5.50 | 1.00 | 3.00 |
| N-alkylurethanes, | | | | | |
| inulin carbamate | | | | | |
| Phenoxyethanol | 0.50 | | | | |
| Perfume, dye | q.s. | q.s. | q.s. | q.s. | q.s. |
| Mineral oil | ad 100 | ad 100 | ad 100 | | |
| Rice oil | | | | ad 100 | ad 100 |

18) Solids-stabilized emulsions

| | 1 | 2 | 3 | 4 | 5 |
|---|---|---|---|---|---|
| Mineral oil | | | 16.00 | 16.00 | |
| Octyldodecanol | 9.00 | 9.00 | 5.00 | | |
| Caprylic/capric | 9.00 | 9.00 | 6.00 | | |
| triglyceride | | | | | |
| C12-15-Alkyl benzoate | | | | 5.00 | 8.00 |
| Butylene glycol | | | | | 8.00 |
| dicaprylate/dicaprate | | | | | |
| Dicaprylyl ether | 9.00 | | | 4.00 | |
| Dicaprylyl carbonate | | 9.00 | | | |
| Hydroxyoctacosanyl | 2.00 | 2.00 | 2.00 | 2.00 | 1.50 |
| hydroxystearate | | | | | |
| Disteardimonium | 1.00 | 0.750 | 0.50 | 0.50 | 0.25 |
| hectorite | | | | | |
| Cera Microcristal- | | | 2.50 | | 5.00 |
| lina + paraffin oil | | | | | |
| Hydroxypropylmethyl- | 0.15 | | | | 0.05 |
| cellulose | | | | | |
| Dimethicone | | | 4.50 | | |
| UVASorb ® K2A | 2.00 | 5.00 | 3.00 | 1.50 | 1.00 |
| Bisethylhexyloxy- | 1.00 | 3.00 | 0.75 | 1.00 | 1.00 |
| phenol methoxy- | | | | | |
| phenyltriazine | | | | | |
| Terephthalidenedicam- | | 2.00 | | | 0.50 |
| phorsulphonic acid | | | | | |
| Phenylbenzimidazole- | 2.00 | 0.50 | 1.00 | | |
| sulphonic acid | | | | | |
| Uvinul ® A Plus | | | 2.75 | | 0.50 |
| Ethylhexyl | 6.00 | | | | 3.0 |
| methoxycinnamate | | | | | |
| Octocrylene | 3.50 | | 7.50 | | |
| Ethylhexyl salicylate | | 3.50 | | | 4.00 |
| Diethylhexylbut- | | | | | 4.0 |
| amidotriazone | | | | | |
| Titanium dioxide | | 2.00 | 4.00 | 2.00 | 4.00 |
| Eusolex ® T-2000 | | | | | |
| Titanium dioxide | | | | | 3.00 |
| T 805 ® | | | | | |
| Silica dimethyl- | | | 1.00 | | |
| silylate | | | | | |
| Boron nitride | 2.00 | | | 3.00 | |
| Tapioca starch | | | | 1.00 | |
| Sodium chloride | 1.00 | 1.00 | 1.00 | 1.00 | |
| Glycerol | 5.0 | 10.0 | | 6.00 | 10.0 |
| Trisodium EDTA | | 1.00 | | 1.00 | |
| Methylparaben | 0.21 | | | | 0.20 |
| Propylparaben | 0.07 | | | | |
| Phenoxyethanol | 0.50 | | 0.40 | 0.40 | 0.50 |
| Hexamidine | | | | | 0.08 |
| diisethionate | | | | | |
| Diazolidinylurea | | | 0.28 | 0.28 | |
| Alcohol | | 5.00 | | 2.50 | |
| Perfume | 0.45 | 0.20 | | | 0.45 |
| Water | ad 100 | ad 100 | ad 100 | ad 100 | ad 100 |

19) Gels

| | % by wt. |
|---|---|
| Eye shadow gel | |
| PEG-8 (polyethylene glycol 400) | 2.00 |
| Ethanol | 5.00 |
| Aristoflex AVC | 1.50 |
| Glycerol | 2.00 |
| Panthenol | 0.50 |
| Tocopherol acetate | 0.50 |
| Timiron Splendid Blue ® (Merck KgaA) | 4.50 |
| Chromium oxide green | 1.00 |
| Perfume, preservative, NaOH, complexing agent, | q.s. |
| dyes, antioxidants etc. | |
| Water | ad 100.00 |
| Highlighter gel | |
| Carbomer | 1.50 |
| Glycerol | 2.50 |
| 1,3-Butylene glycol | 2.50 |
| Glitter pigments (e.g. Helicone HC Scarebeus, Wacker) | 1.00 |
| EDTA | 0.20 |
| Dimethicone | 1.50 |
| Perfume, preservative, NaOH, dyes, antioxidants, etc. | q.s. |
| Water | ad 100.00 |
| Eye liner gel | |
| Pearlescent pigments | 10.00 |
| Iron oxide | 3.00 |
| Silica | 2.00 |
| Aristoflex AVC | 1.00 |
| Hydroxypropylethylcellulose | 0.35 |
| Citric acid | q.s. |
| Glycerol | 5.00 |
| PVP/VA copolymer | 2.00 |
| Perfume, preservative, dyes, NaOH, complexing agent, | q.s. |
| antioxidants, etc. | |
| Water | ad 100.00 |

20) Make-up

| | % by wt. |
|---|---|
| Emulsion make-up | |
| PEG-30 stearate | 2.00 |
| Glycerol monostearate | 1.00 |
| Stearic acid | 1.00 |
| Cyclomethicone | 7.00 |
| Octyldodecanol | 7.00 |
| Isopropyl lanolate | 4.00 |
| Squalane | 2.00 |
| Octyl methoxycinnamate | 2.00 |
| Butylmethoxydibenzoylmethane | 1.00 |
| Xanthan gum | 0.20 |
| Glycerol | 5.00 |
| Butylene glycol | 2.00 |
| Vitamin E acetate | 1.00 |
| Magnesium silicate | 1.00 |
| Mica | 1.00 |
| Iron oxide | 1.00 |
| Titanium dioxide | 2.50 |
| Talc | 5.00 |
| EDTA | 0.50 |
| Perfume, preservative, NaOH, antioxidants, etc. | q.s. |
| Water | ad 100.00 |
| Emulsion make-up | |
| Cyclomethicone and PEG/PPG - 18/18 dimethicone | 10.00 |
| (e.g. Dow Corning 3225 Formulation Aid) | |
| Cyclomethicone | 10.00 |
| Beeswax | 3.00 |
| Polyglyceryl-4 oleate | 2.00 |
| Iron oxide | 1.00 |
| Titanium dioxide | 2.50 |
| Talc | 12.00 |
| Sodium chloride | 2.00 |
| Perfume, preservative, NaOH, antioxidants, etc. | q.s. |
| Water | ad 100.00 |
| Cover cream | |
| Cyclomethicone | 44.00 |
| Beeswax | 3.00 |
| Carnauba wax | 10.00 |
| Lanolin oil | 5.00 |
| Paraffin oil | 8.40 |
| Cetyl alcohol | 2.60 |
| Iron oxide | 3.00 |
| Titanium dioxide | 7.50 |
| Nylon | 6.00 |
| Talc | 10.50 |
| Perfume, preservative, NaOH, antioxidants, etc. | q.s. |
| Emulsion make-up | |
| Cyclomethicone | 18.00 |
| Phenyltrimethicone | 3.00 |
| Cetyl PEG/PPG-10/1 dimethicone (e.g. Abil EM 90) | 4.00 |
| Paraffin oil | 3.00 |
| Iron oxide | 2.30 |
| Titanium dioxide | 4.50 |
| Talc | 2.00 |
| Sodium chloride | 2.00 |
| Quaternium-18 hectorite | 0.30 |
| Propylene carbonate | 0.08 |
| Perfume, preservative, NaOH, antioxidants, etc. | q.s. |
| Water | ad 100.00 |

1. A cosmetic or dermatological product, comprising:
(a) a dispenser comprising:
a container and an inner container wall for housing a cosmetic or dermatological preparation;
a follow-up plunger on a base side of the dispenser, which is capable of being slidably displaced on the inner container wall under the pressure of the ambient atmosphere;
a head section on a top end of the dispenser that can be slidably displaced in relation to the container and that comprises a dispensing channel, the dispensing channel capable of being connected in a communicating manner to the container;
a manually actuable delivery device comprising:
a variable-volume delivery chamber,
a delivery element that can be displaced longitudinally in relation to the container and the head section, comprising a delivery plunger that can be slidably displaced within the delivery chamber and a delivery stem connected to the delivery plunger, and
a delivery channel circumferentially enclosed by the delivery stem and comprising a delivery-channel inlet opening communicating with the delivery chamber and a delivery-channel outlet opening, the delivery channel outlet opening capable of being moved into an open position relative to the dispensing channel by displacing said delivery element; and
(b) a cosmetic or dermatological preparation, comprising water and an auxiliary that keeps the dispenser operating smoothly, the auxiliary selected from the group consisting of (i) polyols having 2 to 6 carbon atoms and 2 to 6 hydroxyl or alkoxy groups and (ii) surfactants that reduce the surface tension of the preparation to less than 30 mN/m.

2. The cosmetic or dermatological product according to claim 1, wherein the delivery-channel outlet opening is on the circumferential surface of the delivery stem and the head section has a bushing that covers the delivery-channel outlet opening in the starting position of the delivery device.

3. The cosmetic or dermatological product according to claim 2, wherein the bushing is designed as a guide bushing that guides the delivery device in a longitudinally displaceable manner and has at least one guide surface interacting with the circumferential surface of the delivery stem.

4. The cosmetic or dermatological product according to claim 3, wherein the delivery plunger projects radially beyond the delivery stem to form an annular abutment surface and the guide bushing has an end-side pressure-exerting surface which, in the starting position, is spaced apart axially from the abutment surface and, by virtue of the head section being displaced axially in the direction of the container, can be positioned on the abutment surface.

5. The cosmetic or dermatological product according to claim 2, wherein carry-along means are provided on the head section and on the delivery device and carry along the delivery device into the starting position following manual actuation when the head section is returned.

6. The cosmetic or dermatological product according to claim 5, wherein a carry-along shoulder is formed on the bushing and interacts with a carry-along ring integrally formed on the delivery stem.

7. The cosmetic or dermatological product according to claim 6, wherein the carry-along shoulder is provided at the end of the bushing at the transition to the dispensing channel, and the carry-along ring is provided in the end region of the delivery stem.

8. The cosmetic or dermatological product according to claim 1, wherein the inner wall of the delivery chamber is formed by an inner sleeve which is provided on the head-section end side of the container.

9. The cosmetic or dermatological product according to claim 8, further comprising a mating head section that includes a retaining cylinder that is fitted in a cup-like manner onto the inner sleeve and a guide cylinder that is arranged concentrically in relation to the retaining cylinder and that guides the sliding displacement of the head section.

10. The cosmetic or dermatological product according to claim 9, whrein the delivery-chamber end of the guide cylinder has a stop for the delivery plunger.

11. The cosmetic or dermatological product according to claim 9, wherein the retaining cylinder is provided with a base-side annular shoulder that forms an abutment surface for a helical spring, retaining the head section under prestressing in the starting position, and is positioned on the end side of the container.

12. The cosmetic or dermatological product according to claim 9, wherein the mating head section has at least one stop for limiting the axial displacement movement of the head section and is formed, together with the head section, as a prefabricated dispenser component and is fastened on the end side of the container.

13. The cosmetic or dermatological product according to claim 12, wherein the dispenser component is latched to the container via latching means formed on the mating head section and the end side of the container.

14. The cosmetic or dermatological product according to claim 1, wherein the head section can be displaced longitudinally such that it can be moved by means of manual actuation from the starting position, in the first instance by a first axial distance in order to butt against the delivery plunger, into a central position, with simultaneous exposure of the delivery-channel outlet opening in the dispensing channel, and it can then be moved, upon continued axial displacement, with the delivery plunger being carried along, from the central position into a final dispensing position, in which the the volume of the delivery chamber is reduced by virtue of displacement of the delivery plunger.

15. The cosmetic or dermatological product according to claim 1, further comprising a closure part that is fastened on the head part and by means of which a product-discharge opening of the dispensing channel can be closed.

16. The cosmetic or dermatological product according to claim 15, wherein the product-discharge opening is formed annularly around a closure pin arranged in the dispensing channel, and wherein the closure part has an annular sealing lip that can be positioned for sealing action on the closure pin.

17. The cosmetic or dermatological product according to claim 15, wherein the closure part is formed from a soft, resilient plastic material.

18. The cosmetic or dermatological product according to claim 17, wherein the closure part is formed from a thermoplastic elastomer.

19. The cosmetic or dermatological product according to claim 15, wherein the closure part is integral with a coating formed at least on the end side of the exterior of the head part.

20. The cosmetic or dermatological product according to claim 1, wherein the auxiliary includes a polyol.

21. The cosmetic or dermatological product according to claim 20, wherein the polyol is selected from the group consisting of glycerol, butylene glycol, propylene glycol, dipropylene glycol, pentanediol, sorbitol, ethylhexylglycerol and panthenol.

22. The cosmetic or dermatological product according to claim 20, wherein the polyol is selected from the group consisting of glycerol, butylene glycol and propylene glycol.

23. The cosmetic or dermatological product according to claim 20, wherein the cosmetic or dermatological preparation includes at least 0.1% by weight of the polyol, based on the total weight of the preparation.

24. The cosmetic or dermatological product according to claim 20, wherein the polyol is present in an amount from 0.5-20% by weight, based on the total weight of the preparation.

25. The cosmetic or dermatological product according to claim 20, wherein the polyol is present in an amount from 1-10% by weight, based on the total weight of the preparation.

26. The cosmetic or dermatological product according to claim 20, wherein the ratio of polyol to water is 1:3 to 1:25.

27. The cosmetic or dermatological product according to claim 1, wherein the auxiliary is a surfactant.

28. The cosmetic or dermatological product according to claim 27, wherein the surfactant has an HLB value of at least 10.

29. The cosmetic or dermatological product according to claim 27, wherein the surfactant is selected from the group consisting of alkyl sulphates and alkyl ether sulphates.

30. A dispensable cosmetic or dermatological preparation, comprising water and an auxiliary that keeps a dispenser dispensing the preparation operating smoothly, the auxiliary selected from the group consisting of (i) polyols having 2 to 6 carbon atoms and 2 to 6 hydroxyl or alkoxy groups and (ii) surfactants that reduce the surface tension of the preparation to less than 30 mN/m.

31. The dispensable cosmetic or dermatological preparation according to claim 30, wherein the auxiliary includes a polyol.

32. The dispensable cosmetic or dermatological preparation according to claim 31, wherein the polyol is selected from the group consisting of glycerol, butylene glycol, propylene glycol, dipropylene glycol, pentanediol, sorbitol, ethylhexylglycerol and panthenol.

33. The dispensable cosmetic or dermatological preparation according to claim 31, wherein the polyol is selected from the group consisting of glycerol, butylene glycol and propylene glycol.

34. The dispensable cosmetic or dermatological preparation according to claim 31, wherein the cosmetic or dermatological preparation includes at least 0.1% by weight of the polyol, based on the total weight of the preparation.

35. The dispensable cosmetic or dermatological preparation according to claim 31, wherein the polyol is present in an amount from 0.5-20% by weight, based on the total weight of the preparation.

36. The dispensable cosmetic or dermatological preparation according to claim 31, wherein the polyol is present in an amount from 1-10% by weight, based on the total weight of the preparation.

37. The dispensable cosmetic or dermatological preparation according to claim 31, wherein the ratio of polyol to water is 1:3 to 1:25.

38. The dispensable cosmetic or dermatological preparation according to claim 30, wherein the auxiliary is a surfactant.

39. The dispensable cosmetic or dermatological preparation according to claim 38, wherein the surfactant has an HLB value of at least 10.

40. The dispensable cosmetic or dermatological preparation according to claim 38, wherein the surfactant is selected from the group consisting of alkyl sulphates and alkyl ether sulphates.

41. A method for improving the operation of a dispenser for dispensing a cosmetic or dermatological preparation so it operates smoothly, the method comprising the step of adding to the cosmetic or dermatological preparation water and an auxiliary selected from the group consisting of (i) polyols having 2 to 6 carbon atoms and 2 to 6 hydroxyl or alkoxy groups and (ii) surfactants that reduce the surface tension of the preparation to less than 30 mN/m.
